(19) United States
(12) Patent Application Publication
(10) Pub. No.: US 2025/0128521 A1
(43) Pub. Date: Apr. 24, 2025

(54) PRINTING SYSTEM, SUBSTRATE STATE ADJUSTMENT METHOD, AND PROGRAM

(71) Applicant: FUJIFILM Corporation, Tokyo (JP)

(72) Inventors: Takashi MITSUYASU, Kanagawa (JP); Hayate NAKAMURA, Kanagawa (JP)

(73) Assignee: FUJIFILM Corporation, Tokyo (JP)

(21) Appl. No.: 18/991,711

(22) Filed: Dec. 23, 2024

Related U.S. Application Data
(63) Continuation of application No. PCT/JP2023/018923, filed on May 22, 2023.

(30) Foreign Application Priority Data
Jul. 15, 2022 (JP) 2022-114096
Apr. 17, 2023 (JP) 2023-067156

(51) Int. Cl. B41J 11/00; B41J 2/045; B41J 2/21

(52) U.S. Cl. CPC B41J 11/00242; B41J 2/04566; B41J 2/2114; B41J 11/00216; B41J 11/00222; B41J 2202/08

(57) ABSTRACT

A printing system that performs double-sided printing includes a first chemical liquid application device that applies a chemical liquid to a first surface of a substrate, a second chemical liquid application device that applies the chemical liquid to a second surface of the substrate, a temperature adjustment device that adjusts a temperature of the substrate, and a moisture content adjustment device that adjusts a moisture content of the substrate, in which the temperature of the substrate when the chemical liquid is applied to the first surface is adjusted to a range exceeding 5.0° C. and lower than a temperature of the chemical liquid, and a first moisture content of the substrate when the chemical liquid is applied to the first surface is adjusted to a range of =5.0% with respect to a second moisture content of the substrate when the chemical liquid is applied to the second surface.

### CROSS-REFERENCE TO RELATED APPLICATIONS

The present application is a Continuation of PCT International Application No. PCT/JP2023/018923 filed on May 22, 2023 claiming priorities under 35 U.S.C § 119(a) to Japanese Patent Application No. 2022-114096 filed on Jul. 15, 2022 and Japanese Patent Application No. 2023-067156 filed on Apr. 17, 2023. Each of the above applications is hereby expressly incorporated by reference, in its entirety, into the present application.

### BACKGROUND OF THE INVENTION

### 1. Field of the Invention

The present invention relates to a printing system, a substrate state adjustment method, and a program.

### 2. Description of the Related Art

JP2017-35870A discloses an image forming device comprising a cooling unit that cools continuous form paper and a humidifying unit that humidifies the continuous form paper. In the apparatus disclosed in JP2017-35870A, humidified air is supplied to the continuous form paper that has cooled to a low temperature, and an ink is jetted onto the continuous form paper whose moisture content is higher than at a normal temperature.

FIG. 6 of JP2017-35870A shows a configuration of double-sided printing comprising a first image forming device, a second image forming device, and an inverting device that inverts the continuous form paper. In the double-sided printing, the continuous form paper on which printing is performed by the first image forming device is inverted by the inverting device and transported to the second image forming device.

The inverting device comprises a transport roll that functions as the cooling unit that cools the continuous form paper and a humidifier that humidifies the continuous form paper, and cools and humidifies the continuous form paper transported from the first image forming device and transports the continuous form paper to the second image forming device.

JP2000-203007A discloses an ink jet recording device that performs printing on paper by jetting ink droplets from a print head and causing the ink droplets to adhere to the paper. In the device disclosed in JP2000-203007A, a moisture content of the paper is adjusted by drying the paper using a pretreatment device provided in front of the print head.

US2021/0060976A discloses a recording system comprising a main body device including a reading device, a recording device, and a paper feeding device, and a post-processing device. In the recording device disclosed in US2021/0060976A, in a case of double-sided recording, a degree of drying of each surface is controlled according to an ink jetting amount for an image to be recorded on each surface, thereby reducing curl of a sheet.

### SUMMARY OF THE INVENTION

However, in the apparatus disclosed in JP2017-35870A, the moisture content of the continuous form paper is adjusted between the first image forming device that performs printing on a front surface of the continuous form paper and the second image forming device that performs printing on a back surface of the continuous form paper. In the apparatus disclosed in JP2017-35870A, it is difficult to adjust the moisture content and the temperature of the continuous form paper transported to the first image forming device.

JP2000-203007A does not disclose double-sided printing. In the device disclosed in JP2000-203007A, the moisture content and the temperature of the paper before printing are adjusted, but adjusting the moisture content of the paper does not necessarily result in a paper state suitable for double-sided printing.

In the device disclosed in US2021/0060976A, it is possible to optimize a drying state of the sheet after printing on each surface, but, in a case in which printing is performed on the back surface after performing printing on the front surface, it is difficult to respond to a change in the state of the sheet before performing printing on the surface that is subjected to printing first.

The present invention has been made in view of such circumstances, and an object of the present invention is to provide a printing system, a substrate state adjustment method, and a program capable of achieving a substrate state suitable for double-sided printing.

A first aspect provides a printing system that performs double-sided printing of performing printing on a first surface of a substrate and then performing printing on a second surface of the substrate opposite to the first surface, the printing system comprising: a first chemical liquid application device that applies a chemical liquid to the first surface of the substrate; a second chemical liquid application device that applies the chemical liquid to the second surface of the substrate having the first surface to which the chemical liquid has been applied; a temperature adjustment device that adjusts a temperature of the substrate; a moisture content adjustment device that adjusts a moisture content of the substrate; one or more processors; and one or more memories in which programs to be executed by the one or more processors are stored, in which the one or more processors execute instructions of the programs to acquire a temperature of the chemical liquid applied to the first surface of the substrate, adjust the temperature of the substrate in a case in which the chemical liquid is applied to the first surface to a range exceeding 5.0° C. and lower than the acquired temperature of the chemical liquid, set a second moisture content which is the moisture content of the substrate in a case in which the chemical liquid is applied to the second surface, and adjust a first moisture content, which is the moisture content of the substrate in a case in which the chemical liquid is applied to the first surface, to a range of plus or minus 5.0% with respect to the second moisture content.

With the printing system according to the first aspect, the first moisture content, which is the moisture content of the substrate in a case in which the chemical liquid is applied to the first surface of the substrate, is adjusted to a range of plus or minus 5.0% with respect to the moisture content of the substrate in a case in which the chemical liquid is applied to the second surface. As a result, a state of the substrate suitable for double-sided printing can be achieved.

The printing may include an aspect in which a functional pattern is formed on the substrate using a functional liquid as the chemical liquid. The formation of the functional pattern includes an aspect in which one type of functional pattern is formed on the entire surface of the substrate.

An example of the chemical liquid is an ink that is dots that make up an image, a pattern, and the like. Another example of the chemical liquid is a pretreatment liquid that is applied to the substrate before the ink is applied to the substrate. An example of the pretreatment liquid is a pretreatment liquid for aggregating or insolubilizing a coloring material contained in the ink.

An example of the substrate is paper media such as sheet paper and continuous form paper. Another example of the substrate is a sheet-like member such as a resin sheet, a metal sheet, and a fabric. The sheet-like member may be in a form such as a single sheet form or a continuous form.

A second aspect provides the printing system according to the first aspect, in which the one or more processors may adjust the first moisture content to a range of plus or minus 2.0% with respect to the second moisture content.

According to such an aspect, it is possible to achieve a more preferable state of the substrate.

A third aspect provides the printing system according to the first or second aspect, in which the moisture content adjustment device may be also used as the temperature adjustment device.

According to such an aspect, it is possible to adjust the moisture content of the substrate by applying the temperature adjustment of the substrate.

A fourth aspect provides the printing system according to the third aspect, in which the temperature adjustment device may adjust the temperature of the substrate by applying at least any of heat conduction, convection, radiation, or dielectric heating.

According to such an aspect, it is possible to apply a temperature control method depending on a temperature control condition, such as the type of the substrate.

A fifth aspect provides the printing system according to the third or fourth aspect, in which the temperature adjustment device may include a heat conduction member that comes into contact with the substrate, and the one or more processors may adjust a surface temperature of the heat conduction member to 60° C. or higher and 140° C. or lower.

According to such an aspect, it is possible to adjust the temperature of the substrate and the moisture content of the substrate by using the surface temperature of the heat conduction member as a parameter.

A sixth aspect provides the printing system according to any one of the third to fifth aspects, in which the temperature adjustment device may include an air blowing device that blows air to the substrate, and the one or more processors may adjust a temperature of the blowing air to 80° C. or higher and 170° C. or lower.

According to such an aspect, it is possible to adjust the temperature of the substrate and the moisture content of the substrate by using the temperature of the blowing air as a parameter.

A seventh aspect provides the printing system according to any one of the third to sixth aspects, in which the temperature adjustment device may include an electromagnetic wave application device that applies an electromagnetic wave to the substrate, and the one or more processors may adjust a wavelength of the electromagnetic wave to 1000 nanometers or more and 8000 nanometers or less.

According to such an aspect, it is possible to adjust the temperature of the substrate and the moisture content of the substrate by using a wavelength range of the electromagnetic wave radiated to the substrate as a parameter.

An eighth aspect provides the printing system according to the seventh aspect, in which the one or more processors may adjust the wavelength of the electromagnetic wave to a range of 3000 nanometers plus or minus 1000 nanometers or a range of 6000 nanometers plus or minus 1000 nanometers.

According to such an aspect, it is possible to adjust the temperature of the substrate and the moisture content of the substrate by using a wavelength range of the electromagnetic wave corresponding to a peak of the water absorption characteristics as a parameter.

A ninth aspect provides the printing system according to any one of the third to eighth aspects, in which the temperature adjustment device may include a cooling device that cools the substrate. According to such an aspect, it is possible to adjust the temperature of the substrate by applying cooling to the substrate.

A tenth aspect provides the printing system according to the ninth aspect, in which the cooling device may include a cooling roller that has an outer peripheral surface brought into contact with the substrate and that accommodates a cooling fluid therein.

According to such an aspect, it is possible to adjust the temperature of the substrate by applying the cooling roller as the cooling device.

An eleventh aspect provides the printing system according to the tenth aspect, in which the cooling device may include a chiller device that supplies the cooling roller with an aqueous liquid adjusted to a specified temperature as the cooling fluid.

According to such an aspect, it is possible to keep a temperature of the cooling fluid constant by circulating the cooling fluid.

A twelfth aspect provides the printing system according to any one of the third to eleventh aspects, in which the one or more processors may automatically control the temperature adjustment device according to an application amount of the chemical liquid.

According to such an aspect, it is possible to adjust the temperature of the substrate according to the application amount of the chemical liquid with respect to the substrate.

A thirteenth aspect provides the printing system according to any one of the third to twelfth aspects, which may further comprise: a first moisture content sensor that detects the first moisture content, which is the moisture content of the substrate in a case in which the chemical liquid is applied to the first surface of the substrate, by using the first chemical liquid application device; and a second moisture content sensor that detects the second moisture content, which is the moisture content of the substrate in a case in which the chemical liquid is applied to the second surface of the substrate, by using the second chemical liquid application device, in which the one or more processors may automatically control the temperature adjustment device such that a moisture content difference calculated by subtracting the first moisture content from the second moisture content is set to zero.

According to such an aspect, it is possible to perform feedback control in the adjustment of the moisture content of the substrate.

A fourteenth aspect provides the printing system according to any one of the third to thirteenth aspects, which may further comprise: a first substrate temperature sensor that detects a first substrate temperature, which is the temperature of the substrate in a case in which the chemical liquid is applied to the first surface of the substrate, by using the first chemical liquid application device; and a second substrate temperature sensor that detects a second substrate temperature, which is the temperature of the substrate in a case in which the chemical liquid is applied to the second surface of the substrate, by using the second chemical liquid application device, in which the one or more processors may automatically control the temperature adjustment device such that a substrate temperature difference calculated by subtracting the first substrate temperature from the second substrate temperature is set to zero.

According to such an aspect, it is possible to perform feedback control in the adjustment of the temperature of the substrate.

A fifteenth aspect provides the printing system according to any one of the first to fourteenth aspects, which may further comprise: a pretreatment liquid application device that applies a pretreatment liquid to the substrate as the chemical liquid.

According to such an aspect, it is possible to achieve optimization of the state of the substrate in a case in which the pretreatment liquid is first applied to the substrate.

A sixteenth aspect provides the printing system according to the fifteenth aspect, in which the temperature adjustment device and the moisture content adjustment device may be disposed to avoid a position of a portion below the pretreatment liquid application device, and may be disposed side by side along a substrate transport direction.

According to such an aspect, it is possible to avoid an influence of heat released from the temperature adjustment device and the moisture content adjustment device on the pretreatment liquid application device.

A seventeenth aspect provides the printing system according to the sixteenth aspect, which may further comprise: a printing device that applies an ink to the substrate as the chemical liquid, in which the temperature adjustment device and the moisture content adjustment device may be disposed to avoid a position of a portion below the printing device, and may be disposed side by side along the substrate transport direction.

According to such an aspect, it is possible to avoid an influence of the heat released from the temperature adjustment device and the moisture content adjustment device on the printing device.

An eighteenth aspect provides the printing system according to any one of the first to fourteenth aspects, which may further comprise: a printing device that applies an ink to the substrate as the chemical liquid.

According to such an aspect, it is possible to achieve optimization of the state of the substrate in a case in which the ink is first applied to the substrate.

A nineteenth aspect provides the printing system according to the eighteenth aspect, in which the temperature adjustment device and the moisture content adjustment device may be disposed to avoid a position of a portion below the printing device, and may be disposed side by side along a substrate transport direction.

According to such an aspect, it is possible to avoid an influence of the heat released from the temperature adjustment device and the moisture content adjustment device on the printing device.

A twentieth aspect provides the printing system according to any one of the first to nineteenth aspects, in which the moisture content adjustment device may include at least any of a first moisture content adjustment device that adjusts a moisture content of the first surface of the substrate or a second moisture content adjustment device that adjusts a moisture content of the second surface of the substrate.

According to such an aspect, misregistration between a first image printed on the first surface and a second image printed on the second surface is suppressed. In addition, crease and cockle generated on the substrate due to permeation of moisture into the substrate are suppressed.

A twenty-first aspect provides the printing system according to the twentieth aspect, in which the first moisture content adjustment device may include a first heat conduction member that comes into contact with the first surface, and the second moisture content adjustment device may include a second heat conduction member that comes into contact with the second surface.

According to such an aspect, occurrence of a difference between a size of the substrate before printing on the first surface and a size of the substrate before printing on the second surface is suppressed.

As the first heat conduction member, a first heat roller having a cylindrical shape and having a surface that is brought into contact with the first surface of the substrate can be applied. As the second heat conduction member, a second heat roller having a cylindrical shape and having a surface that is brought into contact with the second surface of the substrate can be applied.

A twenty-second aspect provides the printing system according to the twenty-first aspect, in which the first moisture content adjustment device may include a first air blowing device that blows air to the first surface, and the second moisture content adjustment device may include a second air blowing device that blows air to the second surface.

In such an aspect, the first air blowing device may be provided as the first moisture content adjustment device, and the second heat conduction member may be provided as the second moisture content adjustment device. In addition, the first heat conduction member may be provided as the first moisture content adjustment device, and the second air blowing device may be provided as the second moisture content adjustment device.

A twenty-third aspect provides the printing system according to any one of the first to twenty-second aspects, in which the moisture content adjustment device may include a first air blowing device that blows air to the first surface as a first moisture content adjustment device that adjusts a moisture content of the first surface of the substrate, and a second air blowing device that blows air to the second surface as a second moisture content adjustment device that adjusts a moisture content of the second surface of the substrate.

According to such an aspect, it is possible to obtain the same effect as that of the twenty-first aspect.

A twenty-fourth aspect provides the printing system according to any one of the first to twenty-third aspects, which may further comprise: a first printing device that performs printing on the first surface, in which the temperature adjustment device may include a first electromagnetic wave irradiation device that irradiates the first surface with an electromagnetic wave after the printing on the first surface, and the one or more processors may start drying treatment for the first surface within 3.0 seconds after the printing on the first surface is completed.

According to such an aspect, good drying treatment for the first surface after printing is implemented, and deformation of the substrate caused by the drying treatment for the first surface after printing is suppressed.

A twenty-fifth aspect provides the printing system according to any one of the first to twenty-fourth aspects, which may further comprise: a first printing device that performs printing on the first surface, in which the temperature adjustment device may include a first electromagnetic wave irradiation device that irradiates the first surface with an electromagnetic wave after the printing on the first surface, and the one or more processors may start drying treatment for the first surface within 1.5 seconds after the printing on the first surface is completed.

According to such an aspect, a remarkable effect is obtained as compared with the twenty-fourth aspect.

A twenty-sixth aspect provides the printing system according to any one of the first to twenty-fifth aspects, which may further comprise: a first printing device that performs printing on the first surface, in which the temperature adjustment device may include a first electromagnetic wave irradiation device that irradiates the first surface with an electromagnetic wave after the printing on the first surface, and the one or more processors may start drying treatment for the first surface within 1.0 second after the printing on the first surface is completed.

According to such an aspect, a remarkable effect can be obtained as compared with the twenty-fifth aspect.

A twenty-seventh aspect provides the printing system according to any one of the first to twenty-sixth aspects, which may further comprise: a second printing device that performs printing on the second surface, in which the temperature adjustment device may include a second electromagnetic wave irradiation device that irradiates the second surface with an electromagnetic wave after the printing on the second surface, and the one or more processors may start drying treatment for the second surface within 3.0 seconds after the printing on the second surface is completed.

According to such an aspect, good drying treatment for the second surface after printing is implemented, and deformation of the substrate caused by the drying treatment for the second surface after printing is suppressed.

A twenty-eighth aspect provides the printing system according to any one of the first to twenty-seventh aspects, which may further comprise: a second printing device that performs printing on the second surface, in which the temperature adjustment device may include a second electromagnetic wave irradiation device that irradiates the second surface with an electromagnetic wave after the printing on the second surface, and the one or more processors may start drying treatment for the second surface within 1.5 seconds after the printing on the second surface is completed.

According to such an aspect, a remarkable effect can be obtained as compared with the twenty-seventh aspect.

A twenty-ninth aspect provides the printing system according to any one of the first to twenty-eighth aspects, which may further comprise: a second printing device that performs printing on the second surface, in which the temperature adjustment device may include a second electromagnetic wave irradiation device that irradiates the second surface with an electromagnetic wave after the printing on the second surface, and the one or more processors may start drying treatment for the second surface within 1.0 second after the printing on the second surface is completed.

According to such an aspect, a remarkable effect can be obtained as compared with the twenty-eighth aspect.

A thirtieth aspect provides the printing system according to any one of the twenty-fourth to twenty-sixth aspects, in which the one or more processors may adjust a surface temperature of the first surface to 50° C. or higher and 95° C. or lower by using the first electromagnetic wave irradiation device.

According to such an aspect, deformation of the first surface is favorably suppressed, and shrinkage of a non-image area on the first surface where an image is not printed is suppressed.

A thirty-first aspect provides the printing system according to any one of the twenty-seventh to twenty-ninth aspects, in which the one or more processors may adjust a surface temperature of the second surface to 50° C. or higher and 95° C. or lower by using the second electromagnetic wave irradiation device.

According to such an aspect, deformation of the second surface is favorably suppressed, and shrinkage of a non-image area on the second surface where an image is not printed is suppressed.

A thirty-second aspect provides the printing system according to any one of the twenty-fourth to twenty-sixth aspects, which may further comprise: a tension application device that applies a tension of 58 newtons per meter or more and 1154 newtons per meter or less to the substrate irradiated with the electromagnetic wave from the first electromagnetic wave irradiation device.

According to such an aspect, in a case of drying the first surface, deformation of the substrate is favorably suppressed, and the breakage of the substrate is suppressed.

A thirty-third aspect provides the printing system according to any one of the twenty-seventh to twenty-ninth aspects, which may further comprise: a tension application device that applies a tension of 58 newtons per meter or more and 1154 newtons per meter or less to the substrate irradiated with the electromagnetic wave from the second electromagnetic wave irradiation device.

According to such an aspect, in a case of drying the second surface, deformation of the substrate is favorably suppressed, and the breakage of the substrate is suppressed.

A thirty-fourth aspect provides t substrate state adjustment method of adjusting a state of a substrate in a case of performing double-sided printing of performing printing on a first surface of the substrate and then performing printing on a second surface of the substrate opposite to the first surface, the substrate state adjustment method comprising: acquiring a temperature of a chemical liquid applied to the first surface; adjusting a temperature of the substrate in a case in which the chemical liquid is applied to the first surface to a range exceeding 5.0° C. and lower than the acquired temperature of the chemical liquid; setting a second moisture content which is a moisture content of the substrate in a case in which the chemical liquid is applied to the second surface; and adjusting a first moisture content, which is a moisture content of the substrate in a case in which the chemical liquid is applied to the first surface, to a range of plus or minus 5.0% with respect to the second moisture content.

According to the substrate state adjustment method of the thirty-fourth aspect, it is possible to obtain the same effects as those of the printing system according to the first aspect.

The configuration requirements of the printing system according to the second to thirty-third aspects can be applied to configuration requirements of the substrate state adjustment method according to the other aspects.

A thirty-fifth aspect provides a program for adjusting a state of a substrate in a case of performing double-sided printing of performing printing on a first surface of the substrate and then performing printing on a second surface of the substrate opposite to the first surface of the substrate, the program causing a computer to implement: a function of acquiring a temperature of a chemical liquid first applied to the first surface; a function of acquiring a temperature of a chemical liquid applied to the first surface; a function of adjusting a temperature of the substrate in a case in which the chemical liquid is applied to the first surface to a range exceeding 5.0° C. and lower than the acquired temperature of the chemical liquid; a function of setting a second moisture content which is a moisture content of the substrate in a case in which the chemical liquid is applied to the second surface; and a function of adjusting a first moisture content, which is a moisture content of the substrate in a case in which the chemical liquid is applied to the first surface, to a range of plus or minus 5.0% with respect to the second moisture content.

According to the program according to the thirty-fifth aspect, it is possible to obtain the same effects as those of the printing system according to the first aspect. The configuration requirements of the printing system according to the second to thirty-third aspects can be applied to configuration requirements of the program according to the other aspects.

According to the present invention, the first moisture content, which is the moisture content of the substrate in a case in which the chemical liquid is applied to the first surface of the substrate, is adjusted to a range of plus or minus 5.0% with respect to the moisture content of the substrate in a case in which the chemical liquid is applied to the second surface. As a result, a state of the substrate suitable for double-sided printing can be achieved.

### BRIEF DESCRIPTION OF THE DRAWINGS

FIG. 1 is an overall configuration diagram of an ink jet printing system according to a first embodiment.

FIG. 2 is a configuration diagram of a preliminary drying device shown in FIG. 1.

FIG. 3 is a configuration diagram of a first printing device shown in FIG. 1.

FIG. 4 is a perspective view showing a configuration example of an ink jet head shown in FIG. 3.

FIG. 5 is a plan view showing a nozzle disposition example of the ink jet head shown in FIG. 3.

FIG. 6 is a functional block diagram showing an electric configuration of the ink jet printing system shown in FIG. 1.

FIG. 7 is a block diagram schematically showing an example of a hardware configuration of the electric configuration shown in FIG. 6.

FIG. 8 is a flowchart showing a procedure of a printing method applied to the ink jet printing system shown in FIG. 1.

FIG. 9 is a flowchart showing a procedure of a preliminary drying condition setting step shown in FIG. 8.

FIG. 10 is a graph showing a relationship between constant rate drying and decreasing rate drying.

FIG. 11 is a graph showing an infrared absorption curve of water.

FIG. 12 is an overall configuration diagram of an ink jet printing system according to a second embodiment.

FIG. 13 is a functional block diagram showing an electric configuration of the ink jet printing system shown in FIG. 12.

FIG. 14 is a block diagram schematically showing an example of a hardware configuration of the electric configuration shown in FIG. 13.

FIG. 15 is a flowchart showing a procedure of a printing method applied to the ink jet printing system shown in FIG. 12.

FIG. 16 is a flowchart showing a procedure of a preliminary drying condition setting step shown in FIG. 15.

FIG. 17 is a table showing a relationship between a difference in moisture content of paper, quality of a printed image, and transport performance of paper.

FIG. 18 is a table showing conditions for carrying out an evaluation experiment from which the table shown in FIG. 17 is derived.

FIG. 19 is a table showing a relationship between a difference in temperature of paper, quality of a printed image, and transport performance of the paper.

FIG. 20 is a table showing conditions for carrying out an evaluation experiment from which the table shown in FIG. 19 is derived.

FIG. 21 is a table showing a relationship between a difference in surface temperature of paper, quality of a printed image, and transport performance of paper.

FIG. 22 is a table showing conditions for carrying out an evaluation experiment from which the table shown in FIG. 21 is derived.

FIG. 23 is a table showing a relationship between a difference in hot air temperature, quality of a printed image, and transport performance of paper.

FIG. 24 is a table showing conditions for carrying out an evaluation experiment from which the table shown in FIG. 23 is derived.

FIG. 25 is a schematic configuration diagram of a preliminary drying device used in an evaluation test regarding expansion and shrinkage of paper.

FIG. 26 is a table showing drying conditions applied to an evaluation test regarding expansion and shrinkage of paper.

FIG. 27 is a table showing results of an evaluation test regarding expansion and shrinkage of paper.

FIG. 28 is a configuration diagram of a first printing device, which shows a disposition example of a radiation drying device.

FIG. 29 is a table showing results of an evaluation test regarding a tension.

FIG. 30 is a table showing results of an evaluation test regarding a time from end of ink droplet jetting to start of radiation drying.

FIG. 31 is a table showing results of an evaluation test regarding a paper surface reaching temperature in the radiation drying.

### DESCRIPTION OF THE PREFERRED EMBODIMENTS

Hereinafter, a preferred embodiment of the present invention will be described with reference to the accompanying drawings. In the present specification, the same components are denoted by the same reference numerals, and duplicate description thereof will be omitted as appropriate.

### Problems

There are two issues of drying performance and image quality of a printed material as problems regarding a moisture content of paper applied to an ink jet printing system. In general, the moisture content of paper used in the ink jet printing system is adjusted to about 7% to 9%. The moisture content in the present specification is a weight moisture content.

The reason for this is that in a case in which the moisture content is too low, the paper becomes hard, making it difficult to transport the paper straight, and the paper is likely to be broken during the transportation of the paper.

On the other hand, in a case in which the moisture content is too high, the strength of the paper is lowered, and a paper failure such as peeling and deformation of a surface layer is likely to occur. Further, the moisture content of the paper varies depending on a fluctuation of environmental temperature and humidity for each manufacturer and for each manufacturing lot, and characteristics of each type of paper. In addition, the moisture content of the paper varies depending on a storage state of the paper at an installation location of the ink jet printing system. In consideration of such circumstances, it is difficult to prepare paper having a constant moisture content as paper to be applied to the ink jet printing system.

### [Problems Regarding Drying Performance]

A drying device that dries paper on which printing is performed is required to have capability of drying both a maximum amount of moisture assumed to be contained in the paper to be fed into a chemical liquid application device that applies a chemical liquid such as a pre-coating liquid and an ink and the chemical liquid to be applied to the paper.

In a case in which the paper to which the chemical liquid has been applied is not sufficiently dried and a surface of the paper to which the chemical liquid has been applied comes into contact with a pass roller or the like, a part of the chemical liquid applied to the paper is transferred to the pass roller, and a failure of the printed material, in which white dots called white spots are generated, may occur. In particular, in a case in which thin paper having a basis weight of 100 grams per square meter or less is applied, the paper is relatively deformed, and the quality of the printed material may be deteriorated.

However, although the moisture content contained in the paper to be fed into the chemical liquid application device is smaller than the amount of the chemical liquid applied to the paper, the moisture content is not negligible, and, in order to achieve robust drying performance, it is necessary to estimate the moisture content contained in the paper to be larger than the actual amount. In this case, the drying device that dries the paper to which the chemical liquid has been applied needs to comprise a large heater or the like, and thus a size of the drying device increases, a cost increases, and power consumption increases.

In particular, in a case in which the chemical liquid is applied to both surfaces of the paper, it is common to comprise a drying device that can make drying performance of a front surface to which the chemical liquid is applied first and drying performance of a back surface to which the chemical liquid is applied later equivalent. In a case in which the chemical liquid is applied to both surfaces of the paper, the drying device is required to have sufficient drying performance for drying the front surface that requires higher drying performance than the back surface, but has an excess drying ability for drying the back surface.

In addition, after the chemical liquid is applied, there is a restriction that a transport member such as a pass roller and a guide plate cannot be brought into contact with the surface of the paper to which the chemical liquid has been applied until the paper is sufficiently dried. In this case, in order to dispose the drying device having a high drying ability and the chemical liquid application device in the same structural portion, it is necessary to comprise a paper transport path that is not in contact with the surface of the paper to which the chemical liquid has been applied for as long a period as possible. In this case, an increase in size of the ink jet printing system and an increase in cost are unavoidable.

There have been ideas in the related art for automatically adjusting an output of the drying device according to the application amount of the chemical liquid, such as the device disclosed in US2021/0060976A, but, with these ideas in the related art, it is difficult to cope with fluctuations in moisture content contained in the paper. That is, with the ideas in the related art, it is difficult to adjust an output of the drying device corresponding to the exact application amount of the chemical liquid, and the output of the drying device has to be set to be high in anticipation of variations in moisture originally contained in the paper. In this case, in the drying device, it is difficult to automatically adjust the drying ability of achieving energy saving.

In particular, in transporting the continuous form paper to which a roll-to-roll method is applied, there are the following problems in realizing a paper transport path that maintains noncontact with the surface of the paper to which the chemical liquid is applied for as long a period as possible, in a rear stage of the chemical liquid application device. A first problem is ensuring a wrap angle of the pass roller in the paper transport path. A second problem is disposing the chemical liquid application device and the drying device based on the viewpoint of reducing the size of the system in the paper transport direction. Specifically, the second problem is disposing the drying device below the chemical liquid application device.

In a case in which the drying device is disposed below the chemical liquid application device, heat generated from the drying device is transferred to the chemical liquid application device disposed above the drying device, which may cause a disturbance in application state of the chemical liquid. In addition, a size in a height direction of a region in which the chemical liquid application device and the drying device are disposed is increased, which may lead to deterioration in maintainability and safety of the chemical liquid application device and deterioration in paper transport performance.

In particular, in a case in which the chemical liquid application device is a printing device and comprises an ink jet head to which an aqueous ink is applied as the chemical liquid, there is a high risk of shortening the life of the ink jet head due to drying deterioration of the extremely expensive ink jet head.

### [Problems Regarding Quality of Product]

In a case in which printing is performed using an aqueous ink as the chemical liquid on paper having a high moisture content and paper having a low temperature, an ink permeates the paper at a slow speed, ink dots spread on the front surface of the paper, and a size of the dots increases. In this case, there is a problem in that a printing resolution is lowered, the inks are likely to mix with each other, the graininess of the printed image is deteriorated, and the quality of the printed image is deteriorated.

In addition, in a case in which ink jet printing is performed using an aqueous ink, heat discharged from the drying device is likely to reach the printing device disposed above the drying device in a case in which the drying device is disposed below the printing device. As a result, in a case in which a temperature around the printing device during printing reaches a temperature equal to or higher than a temperature of an ink jetted from the ink jet head, condensation may occur on the surface of the ink jet head. The condensation on the surface of the ink jet head causes an increase in non-jetting nozzles, and image defects such as streaks may occur in the printed image.

In a double-sided printing device, even in a case in which target image quality can be achieved only by drying treatment performed after printing on each of a front surface and a back surface, a difference in image quality between the front surface and the back surface of the paper may occur because of a difference in moisture content and a difference in temperature between the front surface and the back surface of the paper in a case in which the paper enters the printing device. In particular, in a double-page booklet in which a printed material on which double-sided printing has been performed is applied, a situation occurs in which a printed image on a front surface and a printed image on a back surface are in contact with each other, a difference in image quality between the two is easily visually recognized, and even in a case in which the difference in image quality between the two is slight, it may cause a problem.

In the drying method for paper in the related art, drying conditions for a front surface and a back surface of the paper are adjusted to such an extent that a difference in image quality between the front surface and the back surface of the paper is not visually recognized. However, the image quality may vary depending on a type of paper, a thickness of the paper, an environmental room temperature, and the like, in addition to the moisture content and the temperature of the paper. Therefore, in a case of performing printing on a printed material for which image quality is important, it is necessary to finely adjust the drying conditions each time printing is performed. The fine adjustment of the drying conditions requires advanced adjustment skills of an operator of a high level of craftsmanship and requires great deal of adjustment man-hours. Hereinafter, an ink jet printing system capable of solving the above-described problems will be described in detail.

### [Ink Jet Printing System According to First Embodiment]

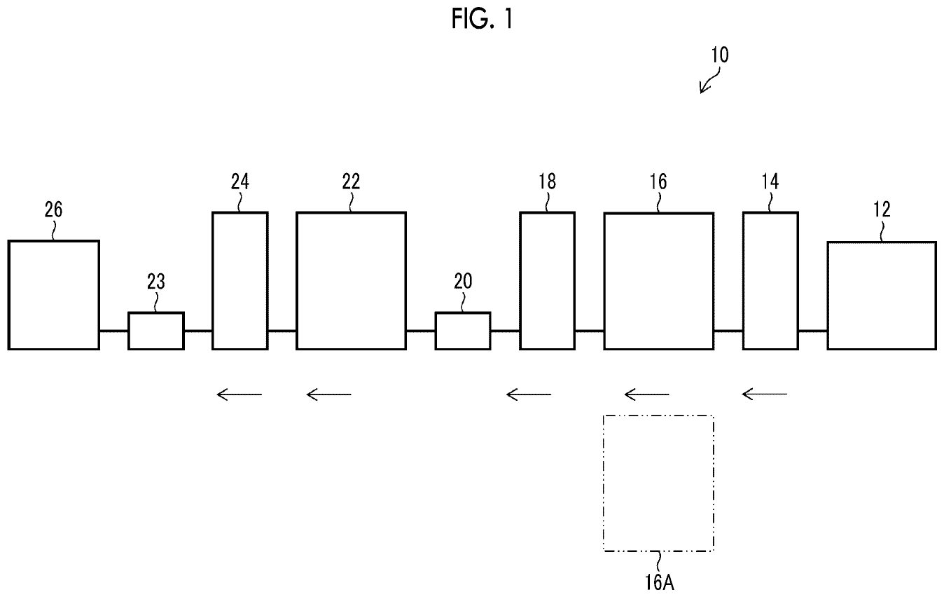

FIG. 1 is an overall configuration diagram of an ink jet printing system according to a first embodiment. An arrow line attached to each device shown in FIG. 1 indicates a transport direction of paper in each device. Hereinafter, the transport direction of paper will be referred to as a paper transport direction. The paper transport direction described in the embodiment is an example of a substrate transport direction.

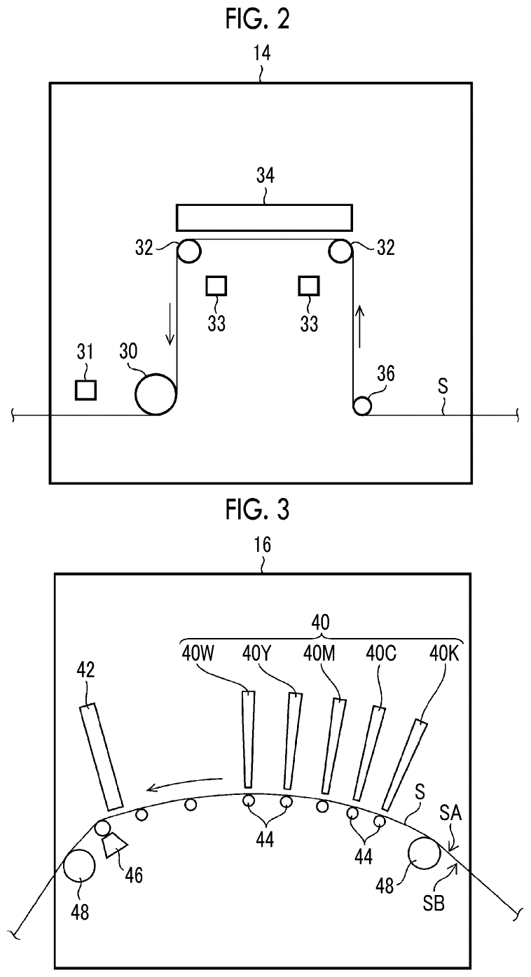

In the present embodiment, the paper is exemplified as a print medium, but a resin sheet, a metal sheet, a fiber sheet such as cloth, or the like may be applied as the print medium. In addition, in the present embodiment, continuous paper is exemplified as the print medium, but sheet paper may be applied as the print medium. In FIG. 1, the paper is not shown. The paper is denoted by reference numeral S and is shown in FIG. 2.

An ink jet printing system 10 shown in FIG. 1 comprises a paper feeding device 12, a preliminary drying device 14, a first printing device 16, a first drying device 18, a paper inverting device 20, a second printing device 22, a second drying device 24, an inspection device 23, and a stacking device 26.

The ink jet printing system 10 is a double-sided printing device that performs printing on a front surface and a back surface of paper supplied from the paper feeding device 12, and uses the preliminary drying device 14 to adjust a moisture content of the paper and a temperature of the paper to be supplied to the first printing device 16. As a result, the moisture content contained in the paper supplied to the first printing device 16 is optimized, and the temperature of the paper is optimized.

### [Paper Feeding Device]

The paper feeding device 12 accommodates paper, which is a printing target, and feeds the paper at a predetermined timing. The paper feeding device 12 comprises a feed mechanism that feeds paper wound in a roll shape at a specified transport speed. In a case in which the paper is sheet paper, the paper feeding device 12 is provided with a stocker and a pickup mechanism that feeds the paper from the stocker one sheet at a time.

The paper feeding device 12 may comprise a paper posture adjustment mechanism that adjusts a posture of the paper. The paper feeding device 12 may comprise a paper sensor that detects a position and a posture of the paper. The paper fed from the paper feeding device 12 is transported to the preliminary drying device 14.

### [Preliminary Drying Device]

The preliminary drying device 14 adjusts a moisture content and a temperature of the paper to be supplied to the first printing device 16. That is, the preliminary drying device 14 comprises a heating device that heats the paper and a cooling device that cools the paper. The paper whose moisture content and temperature are adjusted using the preliminary drying device 14 is transported to the first printing device 16.

The preliminary drying device 14 comprises a transport device that receives the paper fed from the paper feeding device 12 and that transports the paper along a specified transport path. A roller transport system that supports the paper using a plurality of pass rollers can be applied to the transport device for the paper provided in the preliminary drying device 14.

### [First Printing Device]

The first printing device 16 uses an ink jet system to apply an aqueous ink to the front surface of the paper and print a color image on the front surface of the paper. The front surface of the paper is a surface on which printing is performed first, out of one surface and the other surface of the paper. The paper whose front surface has been subjected to the printing using the first printing device 16 is transported to the first drying device 18.

The aqueous ink is an ink that uses water as a solvent, and contains coloring material components that produce an ink color. The aqueous ink has a composition suitable for ink jet system jetting, and is adjusted to have a viscosity suitable for ink jet system jetting in a specified temperature range. As the aqueous ink applied in the present embodiment, a commercially available aqueous ink can be applied.

The first printing device 16 comprises a transport device that transports the paper transported from the preliminary drying device 14 along a specified transport path. A roller transport system that supports the paper using a plurality of pass rollers can be applied to the transport device for the paper provided in the first printing device 16.

The first printing device 16 may comprise an auxiliary drying device that performs auxiliary drying treatment on the paper immediately after printing. The auxiliary drying device may be disposed in the vicinity of an outlet of the paper in the first printing device 16. Reference numeral 16A indicates schematic diagram of a portion below the first printing device 16.

### [First Drying Device]

The first drying device 18 performs drying treatment on the paper whose front surface has been subjected to the printing using the first printing device 16. That is, the first drying device 18 comprises a heating device that heats the paper. The paper on which the drying treatment has been performed using the first drying device 18 is transported to the paper inverting device 20.

The first drying device 18 comprises a transport device that transports the paper transported from the first printing device 16 along a specified transport path. A roller transport system that supports the paper using a plurality of pass rollers can be applied to the transport device for the paper provided in the first drying device 18.

### [Paper Inverting Device]

The paper inverting device 20 receives the paper transported from the first drying device 18 and performs a paper inverting process of switching the front surface and the back surface of the paper. The paper whose front surface and back surface are inverted is transported to the second printing device 22.

The paper inverting device 20 comprises a transport device that transports the paper transported from the first drying device 18 along a specified transport path. A roller transport system that supports the paper using a plurality of pass rollers can be applied to the transport device for the paper provided in the paper inverting device 20.

### [Second Printing Device]

The second printing device 22 uses an ink jet system to apply an aqueous ink to the back surface of the paper and print a color image on the back surface of the paper. The back surface of the paper is a surface opposite to the front surface of the paper. The paper whose back surface has been subjected to the printing using the second printing device 22 is transported to the inspection device 23.

The second printing device 22 comprises a transport device that transports the paper transported from the paper inverting device 20 along a specified transport path. A roller transport system that supports the paper using a plurality of pass rollers can be applied to the transport device for the paper provided in the second printing device 22.

The second printing device 22 may comprise an auxiliary drying device that performs auxiliary drying treatment on the paper immediately after printing. The auxiliary drying device may be disposed in the vicinity of an outlet of the paper in the second printing device 22.

### [Second Drying Device]

The second drying device 24 performs drying treatment on the paper whose back surface has been subjected to the printing using the second printing device 22. The same configuration as the first drying device can be applied to the second drying device 24. In addition, the second drying device 24 comprises a transport device having the same configuration as the transport device for the paper S provided in the first drying device 18.

### [Inspection Device]

The inspection device 23 inspects the printed material and transports the inspected printed material to the stacking device 26. The printed material is paper on which specified printing has been performed, and includes a double-sided printed material in which printing has been performed on one surface and the other surface of the paper. The printed material may include a single-sided printed material in which printing has been performed on only one of one surface or the other surface of the paper.

The inspection device comprises an imaging device and an illumination device, and captures a printed image of an inspection target illuminated with light from the illumination device using the imaging device. The inspection device detects a defect in the printed image of the inspection target based on imaging data of the printed image of the inspection target. The imaging device comprises an image sensor that converts an optical image of the printed material into an electrical signal. The imaging device generates imaging data by converting the optical image of the printed material into the electrical signal, and outputs the imaging data of the printed material.

Examples of the image sensor include a CCD image sensor and a color CMOS image sensor. Note that CCD is an abbreviation for Charge Coupled Device. CMOS is an abbreviation for Complementary Metal Oxide Semiconductor.

In the inspection device, the imaging device and the illumination device may be disposed at positions facing a surface of the paper to be inspected, and the printed material may be imaged using reflected light illumination. In the inspection device, in a case in which transparent paper is applied, the imaging device may be disposed on one surface side and the illumination device may be disposed on the other surface side with a support table that supports the paper interposed therebetween, and the printed material may be imaged using transmitted light illumination.

Here, the printed image may include a text document composed of characters, symbols, and the like. Examples of the defect of the printed material include an abnormality of paper such as ink missing, scratches, stains, and crease. The defect detection for the printed image can be performed using a known method such as a method of comparing the imaging data of the printed material with printing data.

The inspection device 23 comprises a transport device that transports the paper transported from the second printing device 22 along a specified transport path. A roller transport system that supports the paper using a plurality of pass rollers can be applied to the transport device for the paper provided in the inspection device 23.

The transport device of the inspection device 23 may comprise a first imaging device that images the front surface of the paper and a second imaging device that images the back surface of the paper. The transport device of the inspection device 23 may comprise a paper inverting mechanism that inverts the front surface and the back surface of the paper, and the front surface and the back surface of the printed material may be inspected using one imaging device.

### [Stacking Device]

The inspected printed material wound in a roll shape is placed on the stacking device 26. In a case in which sheet paper is applied as the paper, the inspected printed material is stacked and placed on the stacking device 26. The stacking device 26 may sort the printed material that has passed the inspection and the printed material that has failed the inspection.

### [Transport Device]

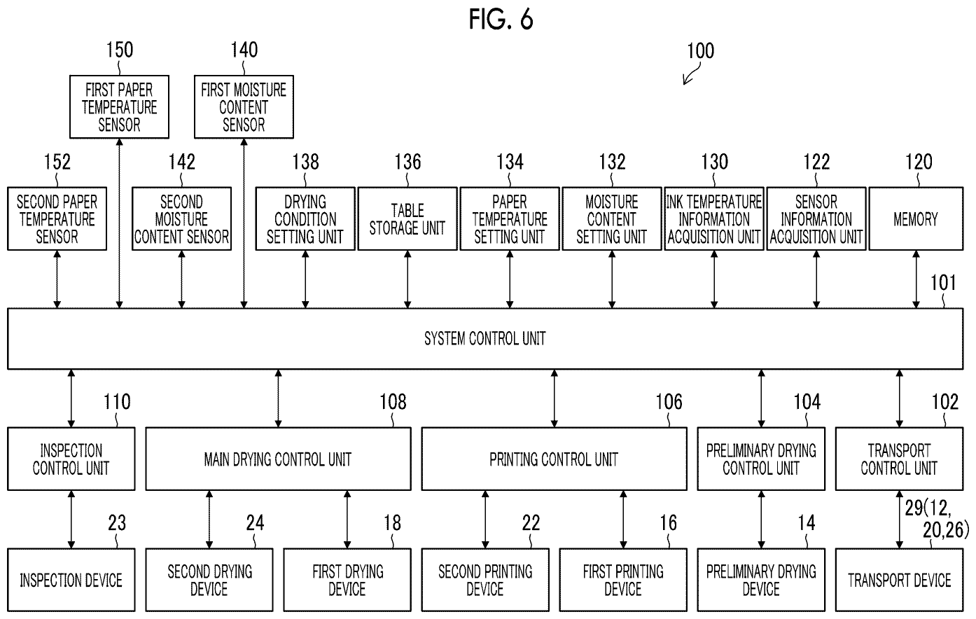

The transport device for the paper provided in the preliminary drying device 14, the transport device for the paper provided in the first printing device 16 and the like, the paper inverting device 20, and the like constitute a transport device that transports the paper from the paper feeding device 12 toward the stacking device 26. In FIG. 1, the transport device is not shown. The transport device is shown in FIG. 6 using reference numeral 29.

### [Configuration Example of Preliminary Drying Device]

FIG. 2 is a configuration diagram of the preliminary drying device shown in FIG. 1. The preliminary drying device 14 adjusts the moisture content of the paper S and the temperature of the paper S, and supplies the paper S adjusted to a specified moisture content and a specified temperature to the first printing device 16. A surface temperature of the paper S can be applied as the temperature of the paper S.

The preliminary drying device 14 comprises a cooling roller 30 that functions as a cooling device, a heat roller 32 that functions as a heating device, and a fan 34 that functions as an air blowing device. The cooling roller 30 and the heat roller 32 can also function as a pass roller that supports the paper S in a case in which the paper S is transported. The cooling roller 30 and the heat roller 32 are disposed in the order of the heat roller 32 and the cooling roller 30 from an upstream side along the paper transport direction.

The preliminary drying device 14 may comprise a plurality of the cooling rollers 30. The plurality of cooling rollers 30 may be consecutively disposed along the paper transport path or may be dispersedly disposed.

A pipe through which cooling water cooled using a chiller device flows is provided inside the cooling roller 30. A surface of the cooling roller 30 is adjusted to a temperature corresponding to a temperature of the cooling water. The cooling roller 30 takes heat away from the paper S that is brought into contact with its outer peripheral surface and cools the paper S.

A cooling roller temperature sensor 31 that measures an outer peripheral surface temperature of the cooling roller 30 is disposed in the vicinity of the cooling roller 30. A noncontact temperature sensor is applied as the cooling roller temperature sensor 31. The chiller device is controlled based on the outer peripheral surface temperature of the cooling roller 30 detected by the cooling roller temperature sensor 31, and the temperature of the cooling water is maintained within a specified temperature range. The cooling roller temperature sensor 31 is not limited to the noncontact type, and a contact type may be applied. The same applies to a heat roller temperature sensor 33 described below.

The vicinity of the cooling roller 30 where the cooling roller temperature sensor 31 is disposed need only be a range in which the outer peripheral surface temperature of the cooling roller 30 can be accurately measured with a specified accuracy using the noncontact cooling roller temperature sensor 31.

A heat source is disposed inside the heat roller 32. An outer peripheral surface temperature of the heat roller 32 is adjusted to a temperature corresponding to a temperature of the heat source. The heat roller 32 transfers heat to the paper S that is brought into contact with its outer peripheral surface to heat the paper S. A hot plate having a flat surface that comes into contact with the paper S may be applied as the preliminary drying device 14. In the preliminary drying device 14, the heat roller 32 and the hot plate may be used in combination.

A heat roller temperature sensor 33 that measures the outer peripheral surface temperature of the heat roller 32 is disposed in the vicinity of the heat roller 32. In an aspect in which a plurality of the heat rollers 32 are provided, each of the plurality of heat rollers 32 is provided with the heat roller temperature sensor 33.

As the heat roller temperature sensor 33, a noncontact temperature sensor can be applied as with the cooling roller temperature sensor 31. A heat source disposed inside the heat roller 32 is controlled based on a surface temperature of the heat roller 32 detected by the heat roller temperature sensor 33, and the outer peripheral surface temperature of the heat roller 32 is maintained at a specified temperature. The vicinity of the heat roller 32 need only be a range in which the outer peripheral surface temperature of the heat roller 32 can be accurately measured with a specified accuracy using the noncontact heat roller temperature sensor 33.

The disposition of the plurality of heat rollers is determined as appropriate based on the viewpoint of maintaining the temperature of the paper S within a specified range. Although an aspect in which two heat rollers 32 are provided is shown in FIG. 2, one heat roller 32 may be provided, or three or more heat rollers 32 may be provided.

The fan 34 blows air to the paper S at a preset air volume to dry the paper S. In the preliminary drying device 14, a plurality of the fans 34 may be dispersedly disposed along the paper transport path. The air volume of the fan 34 may be controlled according to the surface temperature of the paper S. The fan 34 may blow a gas adjusted to a certain temperature to the paper S.

A pass roller 36 is a component of the transport device for the paper S of the preliminary drying device 14, and supports the paper S being transported through the preliminary drying device 14. The preliminary drying device 14 is provided with a plurality of pass rollers (not shown) in addition to the pass roller 36.

In FIG. 2, heat conduction of the cooling roller 30, the heat roller 32, and the like and convection of the fan 34 and the like are exemplified as the system of the preliminary drying device 14, but radiation of an infrared heater and the like and dielectric heating of a high-frequency induction heating device and the like may be applied to the system of the preliminary drying device 14. In addition, an appropriate combination of heat conduction, convection, radiation, and dielectric heating may be applied to the preliminary drying device 14. The first drying device 18 and the second drying device 24 shown in FIG. 1 may have the same configuration as the preliminary drying device 14 shown in FIG. 2.

### [Configuration Example of First Printing Device]

FIG. 3 is a configuration diagram of the first printing device shown in FIG. 1. Here, the first printing device 16 will be described, but the second printing device 22 shown in FIG. 1 may have the same configuration as the first printing device 16 shown in FIG. 3.

The first printing device 16 comprises an ink jet head 40K, an ink jet head 40C, an ink jet head 40M, an ink jet head 40Y, and an ink jet head 40W.

The ink jet head 40K, the ink jet head 40C, the ink jet head 40M, the ink jet head 40Y, and the ink jet head 40W jet a black ink, a cyan ink, a magenta ink, a yellow ink, and a white ink, respectively. Hereinafter, the ink jet head 40K and the like will be referred to as an ink jet head 40 unless otherwise required to distinguish therebetween.

The ink jet head 40 jets an aqueous color ink onto a front surface SA of the paper S to print a color image on the front surface SA of the paper S. The aqueous ink jetted from the ink jet head 40 refers to an ink obtained by dissolving or dispersing a coloring material such as a pigment in a solvent soluble in water. An organic-based pigment is used as the pigment of the aqueous ink. A viscosity of the aqueous ink is 0.5 centipoises or more and 5.0 centipoises or less.

The ink jet head 40 is disposed and positioned such that a nozzle surface for jetting the ink faces a paper transport surface of the paper transport path of the paper S. The ink jet heads 40 are disposed at equal intervals along the paper transport direction.

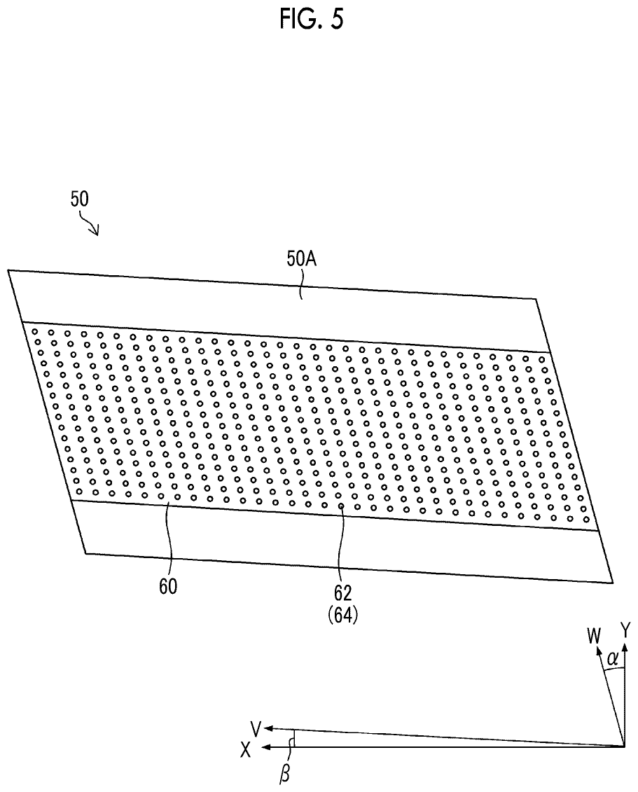

The ink jet head 40 comprises a plurality of nozzles. The nozzles may include nozzle openings and ink flow passages. The ink jet head 40 comprises an energy generation element for each nozzle. A plurality of nozzle openings are disposed on the nozzle surface of the ink jet head 40. A water-repellent film is formed on the nozzle surface of the ink jet head 40. The nozzle opening is denoted by reference numeral 64 and is shown in FIG. 5.

A piezoelectric element can be applied as the energy generation element. The ink jet head 40 comprising the piezoelectric elements jets ink liquid droplets from the nozzle openings using flexural deformation of the piezoelectric elements. Heaters may be applied as the energy generation elements. The ink jet head 40 comprising the heaters jets ink liquid droplets from the nozzle openings using a film boiling phenomenon of the ink.

As the ink jet head 40, a line type head is applied in which a plurality of nozzles are disposed over the entire length of the paper S in a paper width direction that is a direction orthogonal to the paper transport direction and that is parallel to the front surface SA of the paper S. A structure in which a plurality of head modules are connected in the paper width direction may be applied to the line type ink jet head 40.

The ink jet printing system 10 can perform single-pass printing in which the ink jet head 40 and the paper S are moved relative to each other only once to perform printing on the entire surface of the printing region of the paper S. A serial type head may also be applied as the ink jet head 40.

Although an aspect in which aqueous inks of five colors are applied is shown in FIG. 3, ink colors are not limited to the five colors of black, cyan, magenta, yellow, and white. For example, an aspect in which a light-colored ink such as light magenta and light cyan is applied, and an aspect in which a special color ink such as green, orange, violet, clear, and metallic is applied can be applied. In addition, a disposition order of the ink jet heads of the respective colors is not limited to the example shown in FIG. 3.

The first printing device 16 comprises a scanner 42. The scanner 42 comprises an image sensor and an imaging device that captures a test pattern image printed on the front surface SA of the paper S using the image sensor and that converts the captured image into an electrical signal.

In FIG. 3, an illumination device that irradiates the front surface SA of the paper S with illumination light is not shown. In a case in which a transparent film is applied as the paper S, the illumination device is disposed on a back surface SB side of the paper S. On the other hand, in a case in which an opaque medium such as paper is applied as the paper S, the illumination device is disposed on the surface SA side of the paper S.

The test pattern image may be referred to as a test chart, a test pattern, a test image, and the like. Examples of the test pattern image include a test pattern image referred to as a ladder pattern, a 1-on N-off pattern, and the like.

The ink jet printing system 10 specifies a defective nozzle in the ink jet head 40 based on read data of the test pattern image output from the scanner 42. The ink jet printing system 10 performs jetting correction of the ink jet head 40 using defective nozzle information.

FIG. 3 shows a plurality of pass rollers 44 that support the back surface SB of the paper S, a tension pickup 46 that detects a tension applied to the paper S, and a plurality of tension rollers 48 as components of the transport device for the paper S provided in the first printing device 16. The tension roller 48 applies a predetermined tension to the paper S.

### [Configuration Example of Ink Jet Head]

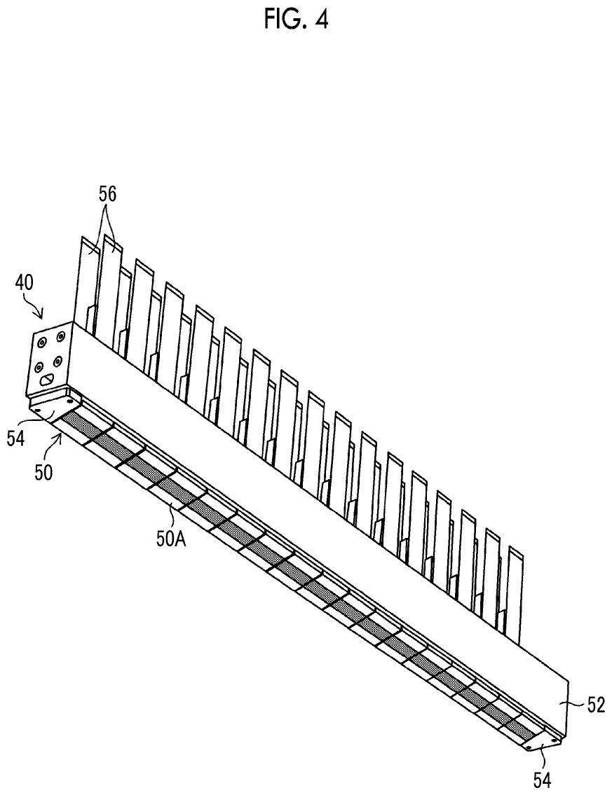

FIG. 4 is a perspective view showing a configuration example of the ink jet head shown in FIG. 3. The ink jet head 40 has a structure in which a plurality of head modules 50 are connected in a line along a longitudinal direction of the ink jet head 40. The plurality of head modules 50 are integrated and supported by using a head frame 52.

The ink jet head 40 is a line head in which a plurality of nozzles are disposed over a length corresponding to the entire width of the paper S in the paper width direction. In FIG. 4, the nozzle is not shown. The nozzle is denoted by reference numeral 62 and is shown in FIG. 5.

A planar shape of a nozzle surface 50A of the head module 50 is a parallelogram. Both ends of the head frame 52 are attached with dummy plates 54. A planar shape of the nozzle surface 50A of the ink jet head 40 is rectangular as a whole in which the head module 50 and the dummy plate 54 are combined.

The head module 50 is attached with a flexible substrate 56. The flexible substrate 56 is a wiring member that delivers a drive voltage to be supplied to the head module 50. One end of the flexible substrate 56 is electrically connected to the head module 50, and the other end is electrically connected to a drive voltage supply circuit. The drive voltage supply circuit is not shown.

Each of the plurality of head modules 50 provided in the ink jet head 40 can be associated with a module number representing a position of the head module 50 in the order from the head module 50 disposed at one end of the ink jet head 40.

FIG. 5 is a plan view showing a nozzle disposition example of the ink jet head shown in FIG. 3. A central portion of the nozzle surface 50A of the head module 50 comprises a nozzle disposition portion 60 having a strip shape. The nozzle disposition portion 60 functions as the substantial nozzle surface 50A.

A plurality of nozzles 62 are disposed in the nozzle disposition portion 60. The nozzle 62 includes a nozzle opening 64 formed in the nozzle surface 50A. A structure example of the nozzles 62 will be described below. In the following description, the disposition of the nozzles 62 may be interpreted as the disposition of the nozzle openings 64.

The head module 50 shown in FIG. 5 has a planar shape of a parallelogram having an edge surface on a long edge side along a direction V having an inclination of an angle β with respect to the paper width direction indicated by reference numeral X and an edge surface on a short edge side along a direction W having an inclination of an angle α with respect to the paper transport direction indicated by reference numeral Y.

In the head module 50, the plurality of nozzles 62 are disposed in a matrix in a row direction along the V direction and in a column direction along the W direction. The nozzles 62 may be disposed along a row direction along the paper width direction and in a column direction that obliquely intersects the paper width direction.

In a case of the ink jet head 40 in which the plurality of nozzles 62 are disposed in a matrix, a projected nozzle column in which each nozzle 62 in the matrix disposition is projected along a nozzle column direction can be considered to be equivalent to one nozzle column in which the respective nozzles 62 are disposed at substantially equal intervals in the nozzle column direction with a density for achieving the maximum recording resolution. The projected nozzle column is a nozzle column in which each nozzle 62 in the matrix disposition is orthographically projected along the nozzle column direction.

The substantially equal interval means that dropping points that can be recorded in the printing device are substantially equal intervals. For example, a case in which the intervals are slightly different to take into account at least any one of a manufacturing error or movement of liquid droplets on the substrate due to the landing interference is also included in the concept of the equal interval. The projected nozzle column corresponds to a substantial nozzle column. In consideration of the projected nozzle column, each nozzle 62 can be associated with a nozzle number representing a nozzle position in the order of disposition of the projected nozzles arranged along the nozzle column direction.

Although FIG. 5 shows, as an example, the ink jet head 40 in which the plurality of nozzles are disposed in a matrix, one column disposition may be applied to the plurality of nozzles, or zigzag disposition of two columns may be applied to the plurality of nozzles.

A substantial density of the nozzles 62 in the paper width direction corresponds to a printing resolution in the paper width direction. Examples of the printing resolution in the paper width direction include 1200 dots per inch. Dots per inch indicating the number of dots per inch may be referred to as dpi using an abbreviation for Dot Per Inch.

### [Electric Configuration of Ink Jet Printing System]

FIG. 6 is a functional block diagram showing an electric configuration of the ink jet printing system shown in FIG. 1. The ink jet printing system 10 shown in FIG. 1 comprises a control device 100 shown in FIG. 6. A computer comprising a processor is applied to the control device 100.

The control device 100 executes various programs to perform operation control of each unit of the ink jet printing system 10. The control device 100 comprises a system control unit 101, a transport control unit 102, a preliminary drying control unit 104, a printing control unit 106, a main drying control unit 108, and an inspection control unit 110.

The system control unit 101 functions as the entire control unit that collectively controls various control units such as the transport control unit 102. The system control unit 101 functions as a memory controller that controls reading out and storing of data from and to a storage device such as a memory 120.

The transport control unit 102 controls an operation of a transport device 29 based on a command signal transmitted from the system control unit 101. That is, the transport control unit 102 operates the transport device 29 based on paper transport conditions set in advance, and performs the transport control of the paper S.

The transport device 29 shown in FIG. 6 includes the transport device for the paper S provided in various devices such as the preliminary drying device 14 and the first printing device 16 shown in FIG. 1. In addition, the transport device 29 includes the paper inverting device 20 shown in FIG. 1. Further, the transport device 29 may include the paper feeding device 12 and the stacking device 26 shown in FIG. 1.

The preliminary drying control unit 104 controls the operation of the preliminary drying device 14 based on a command signal transmitted from the system control unit 101. That is, the preliminary drying control unit 104 operates the preliminary drying device 14 based on preliminary drying conditions set in advance to control preliminary drying treatment of the paper S.

The printing control unit 106 controls the operations of the first printing device 16 and the second printing device 22 based on a command signal transmitted from the system control unit 101. That is, the printing control unit 106 operates the first printing device 16 and the second printing device 22 based on printing conditions set in advance to control printing on the paper S. The printing control unit 106 may comprise a first printing control unit that controls the operation of the first printing device 16 and a second printing control unit that controls the operation of the second printing device 22.

The printing control unit 106 comprises an image processing unit. The image processing unit performs color separation processing, color conversion processing, and halftone processing on the printing data to generate dot data for the printing. The image processing unit may perform various types of correction processing.

The printing control unit 106 comprises a drive voltage generation unit that generates the drive voltage to be supplied to the ink jet head 40 based on halftone data of each color. The printing control unit 106 comprises a drive voltage output unit that outputs the drive voltage to be supplied to the ink jet head 40. The drive voltage output unit includes a power amplification circuit.

The printing control unit 106 comprises a jetting control unit. The jetting control unit generates a jetting control signal for specifying a jetting timing of each nozzle from the dot data generated by using the image processing unit. In addition, the jetting control unit generates a drive waveform signal applied to the drive voltage by using drive waveform data that is generated and stored in advance.

The printing control unit 106 comprises a head drive circuit. The head drive circuit uses the drive waveform signal to generate the drive voltage to be supplied to the piezoelectric element of each nozzle provided in the ink jet head 40. The head drive circuit generates a jetting timing signal for controlling on and off of the piezoelectric element for each nozzle. The head drive circuit supplies the drive voltage to each of the piezoelectric elements for each nozzle at the specified jetting timing.

The main drying control unit 108 controls the operations of the first drying device 18 and the second drying device 24 based on a command signal transmitted from the system control unit 101. That is, the main drying control unit 108 controls main drying treatment on the paper S by operating the first drying device 18 based on first drying conditions set in advance and operating the second drying device 24 based on second drying conditions set in advance.

The inspection control unit 110 controls the operation of the inspection device 23 based on a command signal transmitted from the system control unit 101. That is, the inspection control unit 110 controls the inspection of the printed material by operating the inspection device 23 based on inspection conditions set in advance. The inspection control unit 110 transmits an inspection result of the printed material to the system control unit 101. In accordance with the inspection result of the printed material, the system control unit 101 transmits the command signal for the operation according to the inspection result of the printed material to various control units such as the transport control unit 102.

The control device 100 comprises the memory 120. The memory 120 stores the programs, the parameters, and the data used by the control device 100. The system control unit 101 reads out and executes various programs stored in the memory 120 to implement various functions of the ink jet printing system 10. The system control unit 101 reads out the parameters and the data required for executing various programs from the memory 120.

The control device 100 comprises a sensor information acquisition unit 122. Sensors from which the sensor information acquisition unit 122 acquires sensor information include a plurality of sensors. For example, the plurality of sensors may include temperature sensors such as the cooling roller temperature sensor 31 and the heat roller temperature sensor 33 shown in FIG. 2.

The plurality of sensors include various sensors other than the temperature sensor, such as a paper position detection sensor that detects the position of the paper S. The system control unit 101 transmits command signals to various control units according to the detection results of various sensors indicated by the detection signals acquired by using the sensor information acquisition unit 122.

The control device 100 comprises an ink temperature information acquisition unit 130. The ink temperature information acquisition unit 130 manages a temperature of the ink accommodated inside the ink jet head 40 and maintains the temperature within a certain range. The ink temperature information acquisition unit 130 can acquire ink temperature information from the temperature sensor disposed in the ink flow passage of the ink jet head 40.

The control device 100 comprises a moisture content setting unit 132. The moisture content setting unit 132 sets a target value of a first moisture content which is a moisture content of the paper S in a case of entering the first printing device 16. In addition, the moisture content setting unit 132 sets a target value of a second moisture content which is a moisture content of the paper S in a case of entering the second printing device 22. The moisture content setting unit 132 sets the target value of the first moisture content according to the target value of the second moisture content. The target value of the second moisture content may be specified based on a user input, or may be automatically specified according to printing conditions such as the type of the paper S.

The control device 100 comprises a paper temperature setting unit 134. The paper temperature setting unit 134 sets a target value of a first paper temperature which is a temperature of the paper S in a case of entering the first printing device 16. In addition, the paper temperature setting unit 134 sets a target value of a second paper temperature which is a temperature of the paper S in a case of entering the second printing device 22. The paper temperature setting unit 134 may set the target value of the first paper temperature and the target value of the second paper temperature based on a user input, or may automatically set the target value of the first paper temperature and the target value of the second paper temperature according to printing conditions such as the type of the paper S.

The control device 100 comprises a table storage unit 136. The table storage unit 136 stores various tables applied to various kinds of control of the ink jet printing system 10. The table storage unit 136 may store a temperature conversion table representing a conversion relationship between the moisture content and the temperature of the paper applied to the control of the preliminary drying device 14.

The control device 100 comprises a drying condition setting unit 138. The drying condition setting unit 138 sets preliminary drying conditions applied to the operation control of the preliminary drying device 14. The preliminary drying control unit 104 controls the operation of the preliminary drying device 14 based on the set preliminary drying conditions. The preliminary drying conditions may include the target value of the first moisture content and the target value of the first paper temperature.

The drying condition setting unit 138 sets first drying conditions applied to the operation control of the first drying device 18. In addition, the drying condition setting unit 138 sets second drying conditions applied to the operation control of the second drying device 24. The main drying control unit 108 controls the operation of the first drying device 18 based on the set first drying conditions, and controls the operation of the second drying device 24 based on the set second drying conditions.

The control device 100 comprises a first moisture content sensor 140 and a second moisture content sensor 142. The first moisture content sensor 140 detects the first moisture content. The second moisture content sensor 142 detects the second moisture content. It is preferable that the first moisture content sensor 140 and the second moisture content sensor 142 measure the moisture content of the paper S in a noncontact manner with respect to the paper S. An example of the noncontact moisture content sensor is a near-infrared moisture meter.

The control device 100 comprises a first paper temperature sensor 150 and a second paper temperature sensor 152. The first paper temperature sensor 150 detects the first paper temperature. The second paper temperature sensor 152 detects the second paper temperature. It is preferable that the first paper temperature sensor 150 and the second paper temperature sensor 152 measure the temperature of the paper S in a noncontact manner with respect to the paper S. An example of the noncontact temperature sensor is a radiation thermometer.

The first moisture content sensor 140 and the first paper temperature sensor 150 are disposed at or in the vicinity of an inlet of the first printing device 16 for the paper S. The vicinity of the inlet means a region in which a temperature and a moisture content of the paper S suitable for the temperature and the moisture content of the paper S to be carried into the first printing device 16 can be detected. The vicinity of the inlet may be outside the first printing device 16.

The second moisture content sensor 142 and the second paper temperature sensor 152 are disposed at or in the vicinity of an inlet of the second printing device 22 for the paper S. The vicinity of the inlet means a region in which a temperature and a moisture content of the paper S suitable for the temperature and the moisture content of the paper S to be carried into the second printing device 22 can be detected. The vicinity of the inlet may be outside the second printing device 22.

The preliminary drying control unit 104 performs online automatic temperature control of the preliminary drying device 14 by using the sensor information acquired by using the first moisture content sensor 140, the first paper temperature sensor 150, the second moisture content sensor 142, and the second paper temperature sensor 152.

Specifically, the preliminary drying control unit 104 can perform feedback control of adjusting a power amount applied to the heat roller 32 such that a difference in moisture content obtained by subtracting a detection value of the first moisture content sensor 140 from a detection value of the second moisture content sensor 142 is zero.

In addition, the preliminary drying control unit 104 adjusts the temperature of the cooling water flowing through the inside of the cooling roller 30 such that a difference in temperature obtained by subtracting a detection value of the first paper temperature sensor 150 from a detection value of the second paper temperature sensor 152 is zero, so that the temperature of the paper S of which the moisture content is adjusted becomes a target temperature. In the control in which the moisture content of the paper S is adjusted, in a case in which the amount of heat released from the heat roller 32 is increased, the temperature of the paper S may exceed the target temperature. Therefore, the paper S is cooled by the cooling roller 30, and the target temperature of the paper S is achieved.

Examples of a method of calculating a control input of feedback control for making a difference between the target value and the control target zero include PI control, PD control, P control, and PID control. The P control is proportional control. The PI control is a control method in which P control, which is proportional control, and I control, which is integral control, are combined. The PD control is a control method in which P control and D control, which is differential control, are combined. PID is an abbreviation for Proportional-Integral-Differential.

### [Example of Hardware Configuration of Control Device Applied to Ink Jet Printing System]

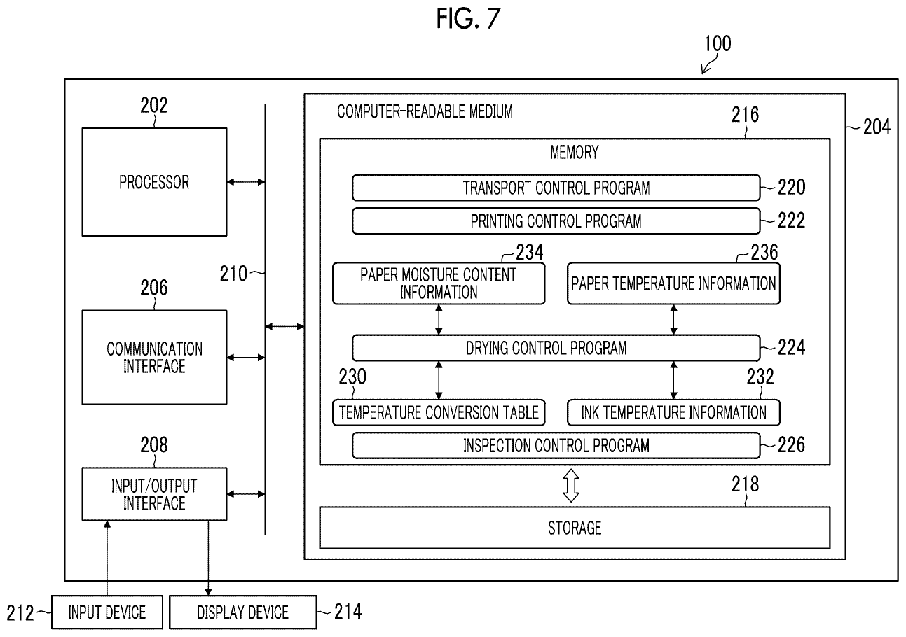

FIG. 7 is a block diagram schematically showing an example of a hardware configuration of the electric configuration shown in FIG. 6. The control device 100 provided in the ink jet printing system 10 comprises a processor 202, a non-transitory tangible computer-readable medium 204, a communication interface 206, and an input/output interface 208.

A computer is applied as the control device 100. A form of the computer may be a server, a personal computer, a workstation, a tablet terminal, and the like.

The processor 202 includes a central processing unit (CPU). The processor 202 may include a graphics processing unit (GPU). The processor 202 is connected to the computer-readable medium 204, the communication interface 206, and the input/output interface 208 via a bus 210. An input device 212 and a display device 214 are connected to the bus 210 via the input/output interface 208.

The computer-readable medium 204 includes a memory 216 which is a main memory and a storage 218 which is an auxiliary memory. A semiconductor memory, a hard disk apparatus, a solid state drive apparatus, and the like may be applied as the computer-readable medium 204. Any combination of a plurality of devices may be applied as the computer-readable medium 204.

The hard disk apparatus can be referred to as an HDD which is an abbreviation for Hard Disk Drive in English. The solid state drive apparatus can be referred to as an SSD which is an abbreviation for Solid State Drive in English.

The control device 100 is connected to a network via the communication interface 206, and is communicably connected to an external device. A local area network (LAN) and the like may be applied to the network. The network is not shown.

The computer-readable medium 204 stores a transport control program 220, a printing control program 222, a drying control program 224, and an inspection control program 226. In addition, the computer-readable medium 204 stores a temperature conversion table 230 and ink temperature information 232.

The transport control program 220 is applied to the transport control unit 102 shown in FIG. 6 to implement a paper transport function of the transport device 29. The printing control program 222 is applied to the printing control unit 106 to implement a printing function using the first printing device 16 and the second printing device.

The drying control program 224 is applied to the preliminary drying control unit 104 and the main drying control unit 108. The drying control program 224 refers to the ink temperature information 232, appropriately refers to paper moisture content information 234 including the first moisture content and the second moisture content, and appropriately refers to paper temperature information 236 including the first paper temperature and the second paper temperature, to implement a preliminary drying function and a main drying function of the paper S. The drying control program 224 may implement the preliminary drying function and the main drying function of the paper S by referring to the temperature conversion table 230.

The inspection control program 226 is applied to the inspection control unit 110. The inspection control program 226 implements an inspection function of the printed material in which the inspection device 23 is used.

Various programs stored in the computer-readable medium 204 include one or more instructions. The computer-readable medium 204 stores various kinds of data, various parameters, and the like. The memory 120 shown in FIG. 6 can be included in the memory 216 of the computer-readable medium 204 shown in FIG. 7.

The ink jet printing system 10 implements various functions of the ink jet printing system 10 by executing the various programs stored in the computer-readable medium 204 via the processor 202. The term “program” is synonymous with the term “software”.

The control device 100 performs data communication with an external device via the communication interface 206. Various standards such as universal serial bus (USB) can be applied to the communication interface 206. As a communication form of the communication interface 206, either wired communication or wireless communication may be applied.

The input device 212 and the display device 214 are connected to the control device 100 via the input/output interface 208. An input device such as a keyboard and a mouse is applied to the input device 212. The display device 214 displays various pieces of information applied to the control device 100.

A liquid crystal display, an organic EL display, a projector, or the like may be applied to the display device 214. Any combination of a plurality of devices may be applied to the display device 214. The term “EL” of the organic EL display is an abbreviation for Electro-Luminescence.

Here, examples of a hardware structure of the processor 202 include a CPU, a GPU, a programmable logic device (PLD), and an application specific integrated circuit (ASIC). The CPU is a general-purpose processor that executes a program and acts as various functional units. The GPU is a processor specialized in image processing.

The PLD is a processor capable of changing a configuration of an electric circuit after manufacturing a device. An example of the PLD is a field programmable gate array (FPGA). The ASIC is a processor comprising a dedicated electric circuit specifically designed to execute a specific process.

One processing unit may be configured by one of these various processors or may be composed of two or more processors of the same type or different types. Examples of a combination of various processors include a combination of one or more FPGAs and one or more CPUs, and a combination of one or more FPGAs and one or more GPUs. Another example of a combination of various processors includes a combination of one or more CPUs and one or more GPUs.

A plurality of functional units may be configured by using one processor. As an example of configuring a plurality of functional units by using one processor, there is an aspect in which, as typified by a computer such as a client or a server, a combination of one or more CPUs and software such as a system on a chip (SoC) is applied to configured one processor, and the processor is caused to act as a plurality of functional units.

As another example of configuring a plurality of functional units by using one processor, there is an aspect in which a processor that realizes functions of an entire system including a plurality of functional units by using one IC chip is used. Note that IC is an abbreviation for integrated circuit.

As described above, the various functional units are configured by using one or more of the above described various processors as a hardware structure. Furthermore, the hardware structure of the above described various processors is, more specifically, an electric circuit (circuitry) in which circuit elements such as semiconductor elements are combined.

The computer-readable medium 204 may include a semiconductor element such as a read only memory (ROM), a random access memory (RAM), and an SSD. The computer-readable medium 204 may include a magnetic storage medium such as a hard disk. The computer-readable medium 204 may be provided with a plurality of types of storage media.

### [Procedure of Printing Method According to First Embodiment]

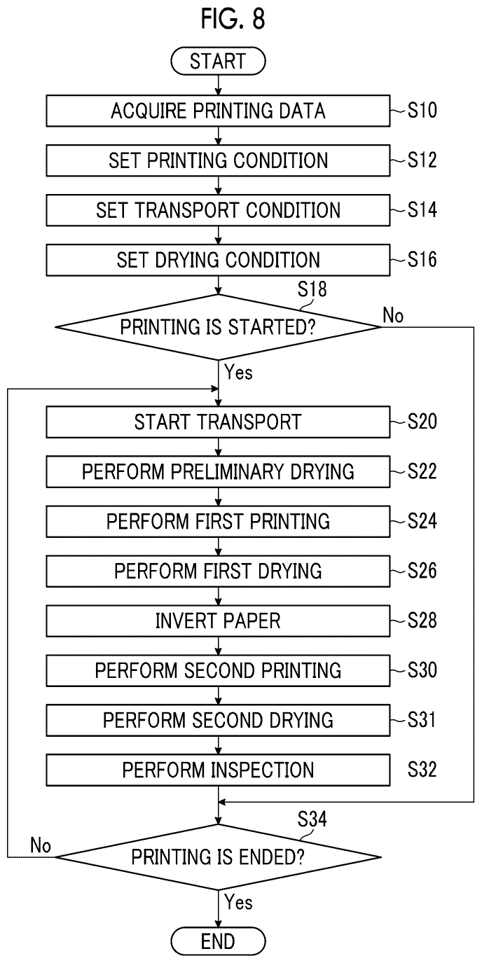

FIG. 8 is a flowchart showing a procedure of a printing method applied to the ink jet printing system shown in FIG. 1. In a printing data acquisition step S10, the printing control unit 106 shown in FIG. 6 acquires printing data. In the printing data acquisition step S10, the acquired printing data is stored. After the printing data acquisition step, the process proceeds to a printing condition setting step S12.

In the printing condition setting step S12, the printing control unit 106 sets the printing conditions such as a printing resolution and the number of printed sheets. The setting may include an aspect of changing the initial setting. After the printing condition setting step S12, the process proceeds to a transport condition setting step S14.

In the transport condition setting step S14, the transport control unit 102 sets the transport conditions applied to the transport of the paper S. The transport condition setting step S14 may be switched in order with the printing condition setting step S12, or may be executed in parallel with the printing condition setting step S12. After the transport condition setting step S14, the process proceeds to a drying condition setting step S16.

In the drying condition setting step S16, the drying condition setting unit 138 sets the preliminary drying conditions to be applied to the preliminary drying device 14, for the preliminary drying control unit 104. In addition, in the drying condition setting step S16, the drying condition setting unit 138 sets the first drying conditions to be applied to the first drying device 18 and sets the second drying conditions to be applied to the second drying device 24, for the main drying control unit 108. The details of the preliminary drying conditions will be described below. After the drying condition setting step S16, the process proceeds to a printing start determination step S18.

In the printing start determination step S18, the printing control unit 106 determines whether or not a specified printing start condition is satisfied. In the printing start determination step S18, in a case in which the printing control unit 106 determines that the specified printing condition is not satisfied, No determination is made. In a case of the No determination, the process proceeds to a printing end determination step S34.

On the other hand, in the printing start determination step S18, in a case in which the printing control unit 106 determines that the specified printing condition is satisfied, Yes determination is made. In a case of the Yes determination, the process proceeds to a transport start step S20.

In the transport start step S20, the transport control unit 102 operates the transport device 29 by applying the transport conditions set in the transport condition setting step S14, and starts the transport of the paper S from the paper feeding device 12 to the stacking device 26 shown in FIG. 1. In a case in which the transport start step S20 is executed, the process proceeds to a preliminary drying step S22.

In the preliminary drying step S22, the preliminary drying control unit 104 operates the preliminary drying device 14 by applying the preliminary drying conditions set in the drying condition setting step S16. After the preliminary drying treatment is performed on the paper S in the preliminary drying step S22, the process proceeds to a first printing step S24.

In the first printing step S24, the printing control unit 106 operates the first printing device 16 by applying the printing conditions set in the printing condition setting step S12, and performs printing on the front surface SA of the paper S. In a case in which printing on the front surface SA of the paper S is performed in the first printing step S24, the process proceeds to a first drying step S26.

In the first printing step S24, an auxiliary drying step in which the auxiliary drying device provided in the first printing device 16 is used may be executed. In the auxiliary drying step, the printed image printed on the front surface SA of the paper S is subjected to treatment of drying the printed image to such an extent that the printed image does not move to the transport member in a case in which the transport member such as a pass roller comes into contact with the printed image printed on the front surface SA of the paper S.

In the first drying step S26, the main drying control unit 108 operates the first drying device 18 by applying the first drying conditions set in the drying condition setting step S16, and performs first drying treatment on the front surface SA of the paper S on which the printing is performed in the first printing step S24. In the first drying step S26, a drying intensity sufficient to fix the printed image to the front surface SA of the paper S is applied. After the first drying step S26, the process proceeds to a paper inverting step S28.

In the paper inverting step S28, the transport control unit 102 operates the paper inverting device 20 to invert the front surface SA and the back surface SB of the paper S. After the paper inverting step S28, the process proceeds to a second printing step S30.

In the second printing step S30, the printing control unit 106 operates the second printing device 22 by applying the printing conditions set in the printing condition setting step S12, and performs printing on the back surface SB of the paper S. In a case in which printing on the back surface SB of the paper S is performed in the second printing step S30, the process proceeds to a second drying step S31.

In the second printing step S30, an auxiliary drying step in which the auxiliary drying device provided in the second printing device 22 is used may be executed. In the auxiliary drying step, treatment of drying the printed image to such an extent that the ink of the printed image does not move to the transport member in a case in which the transport member such as a pass roller comes into contact with the printed image printed on the front surface SA of the paper S is performed.

In the second drying step S31, the main drying control unit 108 operates the second drying device 24 by applying the second drying conditions set in the drying condition setting step S16, and performs second drying treatment on the back surface SB of the paper S on which the printing is performed in the second printing step S30.

In the second drying step S31, the printed image printed on the back surface SB of the paper S is fixed to the back surface SB of the paper S to such an extent that image defects do not occur even in a case in which contact with the inspection device 23 occurs in an inspection step S32. After the second drying step S31, the process proceeds to the inspection step S32.

In the inspection step S32, the inspection control unit 110 operates the inspection device 23 to perform the inspection of the printed image printed on the front surface SA of the paper S and the printed image printed on the back surface SB of the paper S. In the inspection step S32, the quality of each of the printed images printed on both surfaces of the paper S is determined. In the inspection step S32, inspection result of the printed images printed on both surfaces of the paper S may be stored. After the inspection step S32, the process proceeds to the printing end determination step S34.

In the printing end determination step S34, the printing control unit 106 determines whether or not a specified printing end condition is satisfied. In the printing end determination step S34, in a case in which the printing control unit 106 determines that the specified printing end condition is not satisfied, No determination is made.

In a case of the No determination, the process proceeds to the transport start step S20, and each step from the transport start step S20 to the printing end determination step S34 is repeatedly executed until Yes determination is made in the printing end determination step S34.

On the other hand, in the printing end determination step S34, in a case in which the printing control unit 106 determines that the specified printing end condition is satisfied, Yes determination is made. In a case of the Yes determination, a specified printing end process is performed, and the procedure of the printing method is ended.

### [Details of Preliminary Drying Condition Setting Step]

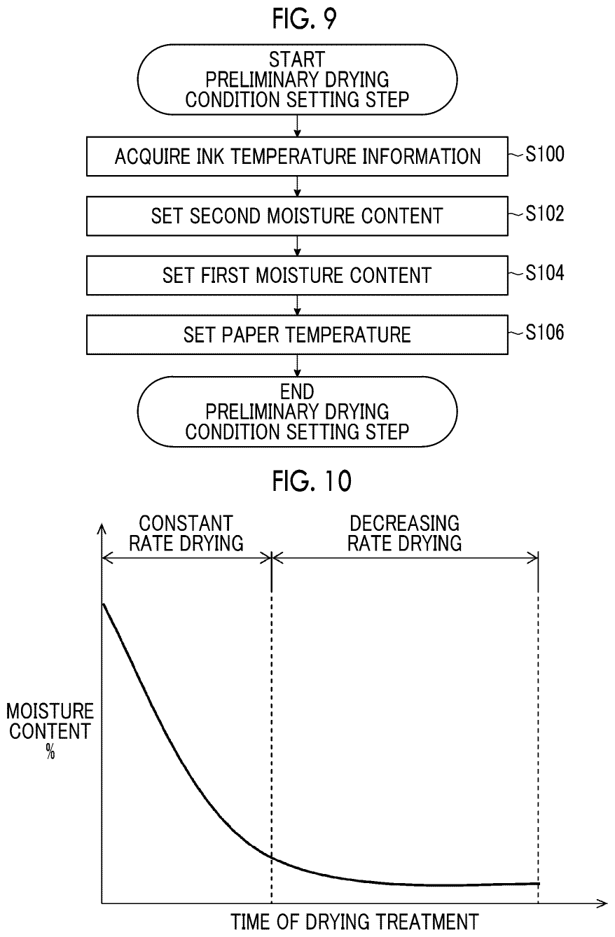

FIG. 9 is a flowchart showing a procedure of a preliminary drying condition setting step. FIG. 9 shows a procedure of a preliminary drying condition setting step of setting the preliminary drying conditions applied to the preliminary drying device 14 shown in FIG. 1 in the drying condition setting step S16 shown in FIG. 8.

In an ink temperature information acquisition step S100, the preliminary drying control unit 104 shown in FIG. 6 acquires ink temperature information including the temperature of the ink jetted from the ink jet head 40 via the ink temperature information acquisition unit 130. After the ink temperature information acquisition step S100, the process proceeds to a second moisture content setting step S102.

In the second moisture content setting step S102, the moisture content setting unit 132 shown in FIG. 6 sets the second moisture content. After the second moisture content setting step S102, the process proceeds to a first moisture content setting step S104.

In the first moisture content setting step S104, the moisture content setting unit 132 shown in FIG. 6 sets the first moisture content according to the second moisture content.

Specifically, in a case in which the second moisture content is set to W2 percent, a first moisture content W1 is set to a range of plus or minus 5.0% with respect to the second moisture content W2. The first moisture content W1 is more preferably in a range of plus or minus 2.0% with respect to the second moisture content W2. After the first moisture content setting step S104, the process proceeds to a paper temperature setting step S106.

In the paper temperature setting step S106, the paper temperature setting unit 134 sets the target value of the first paper temperature according to the temperature of the ink acquired in the ink temperature information acquisition step S100. In a case in which the temperature of the ink is denoted by TI, a target value of a first paper temperature TW is set in a range satisfying 5.0° C.<TW<TI. In the paper temperature setting step S106, in a case in which the target value of the first paper temperature TW is set, the procedure of the preliminary drying condition setting step is ended.

The printing method showing the procedure shown in FIG. 8 and the preliminary drying condition setting step showing the procedure shown in FIG. 9 can be understood as a paper state adjustment method for adjusting the paper state. The paper state adjustment method described in the embodiment is an example of a substrate state adjustment method.

### [Details of Preliminary Drying Treatment]

Next, the preliminary drying treatment performed using the preliminary drying device 14 shown in FIG. 1 will be described in detail. The ink jet printing system 10 shown in FIG. 1 is provided with the preliminary drying device 14 as a device for adjusting the moisture content of the paper S and the temperature of the paper S by combining drying and cooling, before the ink is applied to the front surface SA of the paper S. As a result, the amount of water contained in a large amount in the paper S to be fed into the ink jet printing system 10 is sufficiently reduced, and the temperature of the paper S is maintained in a certain range.

The preliminary drying device 14 may automatically adjust the amount of heat applied to the paper S according to the amount of ink applied to the front surface of the paper S using the first printing device 16. The amount of ink applied to the front surface of the paper S using the first printing device 16 can be calculated based on the printing data.

As the moisture of the paper S is sufficiently dried, the drying state transitions from a constant rate drying state to a decreasing rate drying state, and the change in the moisture content of the paper S is slowed down. In this case, the paper S is heated with a sufficient amount of heat, and the moisture contained in the paper S can be made constant with a specified accuracy.

FIG. 10 is a graph showing a relationship between constant rate drying and decreasing rate drying. In the graph shown in FIG. 10, a horizontal axis represents a time of the drying treatment on the paper S, and a vertical axis represents a moisture content of the paper S. The unit of the moisture content is percent.

As shown in FIG. 10, in a case in which the paper S is heat with a sufficient amount of heat, the moisture content of the paper S can be controlled in both the constant rate drying state and the decreasing rate drying state. The amount of heat applied to the paper S can be controlled using a treatment temperature in a case in which the paper S is heated as a parameter.

The paper S contains mostly water and little solvent. Therefore, the moisture content of the paper S can be adjusted by a simple drying method. The preliminary drying device 14 can set the moisture content contained in the paper S in a case of entering the first printing device 16 to a constant amount, and the drying ability of the first drying device 18 that performs the first drying after the printing on the front surface SA of the paper S is sufficient as long as the ink applied to the front surface SA of the paper S can be dried. Similarly, the drying ability of the second drying device 24 that performs the second drying after the printing on the back surface SB of the paper S is sufficient as long as the ink applied to the back surface SB of the paper S can be dried.

The amount of ink applied to the front surface SA of the paper S is managed by the first printing device 16. Therefore, the first drying device 18 is applied with automatic control, and can perform the drying treatment with a high accuracy and implement energy-saving drying treatment. Similarly, the amount of ink applied to the back surface SB of the paper S is managed by the second printing device 22, so that the second drying device 24 is applied with automatic control, and can perform the drying treatment with a high accuracy and implement energy-saving drying treatment.

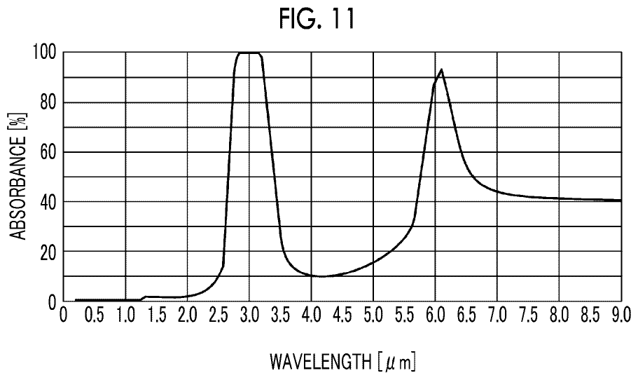

The preliminary drying device 14 comprising an infrared heater is effective in a case in which a wavelength of infrared light matches with an absorption wavelength of water. FIG. 11 is a graph showing an infrared absorption curve of water. A horizontal axis of the graph shown in FIG. 11 represents a wavelength of infrared light, and the unit thereof is micrometers. A vertical axis of the graph shown in FIG. 11 represents an absorbance, and the unit thereof is percent.

The graph shown in FIG. 11 shows that water absorption occurs in a case in which the wavelength of infrared light is in a range of 1.0 micrometer or more and 8.0 micrometers or less. In addition, the graph shown in FIG. 11 shows that there is a peak in the absorbance in a case in which the wavelength of infrared light is 3.0 micrometers, and that preferred absorption of water occurs in a case in which the wavelength of infrared light is in a range of 2.0 micrometers to 4.0 micrometers. Further, the graph shown in FIG. 11 shows that there is a peak in the absorbance in a case in which the wavelength of infrared light is 6.0 micrometers, and that preferred absorption of water occurs in a case in which the wavelength of infrared light is in a range of 5.0 micrometers to 7.0 micrometers.

That is, the preliminary drying device 14 comprising the infrared heater is preferably set to have a wavelength of infrared light in a range of 1000 nanometers or more and 8000 nanometers or less. The wavelength of infrared light is more preferably in a range of 3000 nanometers plus or minus 1000 nanometers and in a range of 6000 nanometers plus or minus 1000 nanometers.

### Effect of First Embodiment

The ink jet printing system 10 and the like according to the first embodiment can obtain the following effects.

[1]

The excess moisture contained in the paper S is reduced and adjusted to a preferred moisture content of the paper S before the paper S enters the first printing device 16 where the ink is first applied to the paper S. As a result, the first drying device 18 can have a minimum drying ability required for the drying treatment of the front surface SA of the paper S to which the ink has been applied, and can achieve the reduction in size and the suppression of the cost of the first drying device 18.

In addition, the second drying device 24 can also have a minimum drying ability required for the drying treatment of the back surface SB of the paper S to which the ink has been applied, and can achieve the reduction in size and the suppression of the cost.

[2]

In the first drying device 18, generation of excess heat energy is suppressed. As a result, the drying of the ink jet head 40 caused by the thermal energy released from the first drying device 18 is suppressed. Drying of the ink inside the nozzle 62 and adhesion of a solidified substance of the ink to the vicinity of the nozzle opening 64 are suppressed, and occurrence of a fatal failure of the ink jet head 40, such as jetting failure, is suppressed. In the second drying device 24 as well, as with the first drying device 18, the generation of excess heat energy is suppressed, and the occurrence of the problem caused by the heat energy released from the second drying device 24 is suppressed.

[3]

The moisture content and the temperature of the paper S are optimized before the paper S enters the first printing device 16 where the ink is first applied to the paper S. As a result, the spread and permeation of the ink on the paper S are made constant, thereby ensuring the specified printed image quality.

[4]

Fluctuations in the printing environment, such as temperature and humidity fluctuations due to the seasonal variation and the weather, are suppressed. As a result, the temperature fluctuation, the humidity fluctuation, and the like of the paper S caused by the fluctuations in the printing environment are suppressed, and the fluctuation in the quality of the printed image is suppressed.

[5]

In a case in which the paper S has a relatively high moisture content, the ink permeates the paper S relatively slowly, and there is a concern that the inks may be mixed together. On the other hand, the moisture content and the temperature of the paper S are optimized, so that the mixing of the inks is suppressed, and particularly, the deterioration in the quality of the printed image due to the deterioration of the graininess of the printed image can be suppressed.

[6]

In the double-sided printing, the first moisture content W1 is adjusted according to the second moisture content W2. Specifically, the first moisture content W1 is adjusted to a range of plus or minus 5.0% of the second moisture content W2. In addition, the first paper temperature TW is adjusted according to the ink temperature TI. Specifically, the first paper temperature TW is set to a range exceeding 5.0° C. and lower than the ink temperature TI. As a result, a quality difference in the printed image between the front surface SA of the paper S and the back surface SB of the paper S can be suppressed. In particular, in a case in which a booklet, a direct mail, or the like is created by folding a double-sided printed material, a value of ensuring that the quality of the printed image on the front surface SA of the paper S and the back surface SB of the paper S adjacent to each other is consistent is great.

The front surface SA of the paper S described in the embodiment is an example of a first surface of a substrate, and the back surface SB of the paper S is an example of a second surface of the substrate. The first printing device 16 described in the embodiment is an example of a first chemical liquid application device, and the second printing device 22 is an example of a second chemical liquid application device.

The preliminary drying device 14 described in the embodiment is an example of a temperature adjustment device, an example of a moisture content adjustment device, and an example of a moisture content adjustment device that is also used as a temperature adjustment device. The range of the first paper temperature TW described in the embodiment is an example of a range exceeding 5.0° C. and lower than an acquired temperature of a chemical liquid.

The cooling roller 30 described in the embodiment is a cooling roller that has an outer peripheral surface brought into contact with the substrate, and is an example of a cooling roller that accommodates a cooling fluid therein. The cooling water flowing through the inside of the cooling roller described in the embodiment is an example of a cooling medium and is an example of an aqueous liquid. The heat roller 32 described in the embodiment is an example of a heat conduction member. The infrared heater described in the embodiment is an example of an electromagnetic wave application device that applies an electromagnetic wave to the substrate.

The first paper temperature sensor 150 described in the embodiment is an example of a first substrate temperature sensor that detects a first substrate temperature. The second paper temperature sensor 152 described in the embodiment is an example of a second substrate temperature sensor that detects a second substrate temperature. The difference in temperature obtained by subtracting the detection value of the first paper temperature sensor 150 from the detection value of the second paper temperature sensor 152 described in the embodiment is an example of a substrate temperature difference.

### [Ink Jet Printing System According to Second Embodiment]

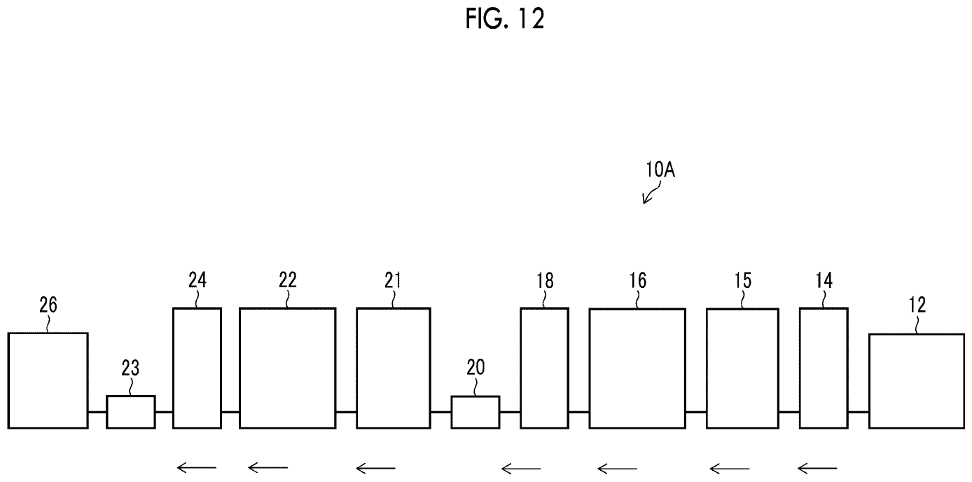

FIG. 12 is an overall configuration diagram of an ink jet printing system according to a second embodiment. An ink jet printing system 10A shown in FIG. 12 is configured by adding a first pre-coating device 15 and a second pre-coating device 21 to the ink jet printing system 10 shown in FIG. 1. In FIG. 12, a portion below the first pre-coating device 15 corresponding to the portion 16A below the first printing device 16 shown in FIG. 1 is not shown.

The first pre-coating device 15 is disposed at a position on a downstream side of the preliminary drying device 14 in the paper transport direction and at a position on an upstream side of the first printing device 16. The first pre-coating device 15 applies a pre-coating liquid to the front surface SA of the paper S before printing.

The first pre-coating device 15 may use a roller coating method of applying a measured amount of pre-coating liquid to a coating roller and coating the front surface SA of the paper S with the measured amount of pre-coating liquid from the coating roller. The same applies to the second pre-coating device 21.

The second pre-coating device 21 is disposed at a position on the downstream side of the paper inverting device 20 in the paper transport direction and at a position on the upstream side of the second printing device 22. The second pre-coating device 21 applies a pre-coating liquid to the back surface SB of the paper S before printing.

The pre-coating liquid contains a component that reacts with an ink to aggregate or insolubilize a coloring material contained in the ink. For example, an acidic liquid can be applied as the pre-coating liquid. The same composition of the pre-coating liquid can be applied to the first pre-coating device 15 and the second pre-coating device 21. In a case in which the pre-coating liquid is used, an aqueous ink contains a material that reacts with the pre-coating liquid to exhibit a function of aggregating or insolubilizing the coloring material.

In the ink jet printing system 10A shown in FIG. 12, the preliminary drying device 14 is disposed to avoid the portion below the first pre-coating device 15. In addition, the preliminary drying device 14 may be disposed to avoid the portion 16A below the first printing device 16 shown in FIG. 1.

### [Electric Configuration of Ink Jet Printing System]

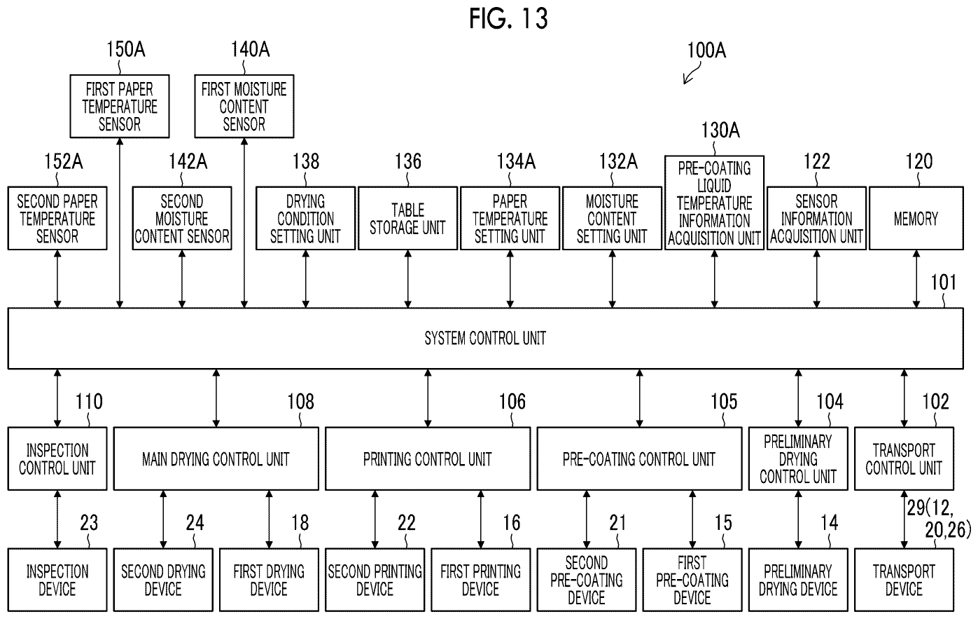

FIG. 13 is a functional block diagram showing an electric configuration of the ink jet printing system shown in FIG. 12. A control device 100A shown in FIG. 13 is configured by adding a pre-coating control unit 105 to the control device 100 shown in FIG. 6.

The pre-coating control unit 105 controls the operations of the first pre-coating device 15 and the second pre-coating device 21 based on a command signal transmitted from the system control unit 101. That is, the pre-coating control unit 105 operates the first pre-coating device 15 based on first pre-coating conditions applied to the first pre-coating device 15 to control the pre-coating on the front surface SA of the paper S.

In addition, the pre-coating control unit 105 operates the second pre-coating device 21 based on second pre-coating conditions applied to the second pre-coating device 21 to control the pre-coating on the back surface SB of the paper S.

The pre-coating control unit 105 may comprise a first pre-coating control unit that controls the operation of the first pre-coating device 15 and a second pre-coating control unit that controls the operation of the second pre-coating device 21.

The preliminary drying control unit 104 operates the preliminary drying device 14 to adjust a first moisture content which is a moisture content of the paper S in a case of entering the first pre-coating device 15. In addition, the preliminary drying control unit 104 operates the preliminary drying device 14 to adjust a first paper temperature which is a temperature of the paper S in a case of entering the first pre-coating device 15.

The preliminary drying device 14 may automatically adjust the amount of heat applied to the paper S according to the application amount of pre-coating liquid applied to the front surface of the paper S using the first pre-coating device 15. The application amount of the pre-coating liquid applied to the front surface of the paper S using the first pre-coating device 15 can be calculated based on the printing data.

The control device 100A comprises a pre-coating liquid temperature information acquisition unit 130A instead of the ink temperature information acquisition unit 130 shown in FIG. 6. The pre-coating liquid temperature information acquisition unit 130A shown in FIG. 13 acquires pre-coating liquid temperature information including the temperature of the pre-coating liquid supplied to the first pre-coating device 15. The temperature of the pre-coating liquid supplied to the first pre-coating device 15 can be detected by using a temperature sensor provided in the first pre-coating device 15.

The control device 100A comprises a moisture content setting unit 132A instead of the moisture content setting unit 132 shown in FIG. 6. The moisture content setting unit 132A shown in FIG. 13 sets a target value of the first moisture content, which is the moisture content of the paper S in a case of entering the first pre-coating device 15, according to a target value of a second moisture content which is a moisture content of the paper S in a case of entering the second pre-coating device 21.

The control device 100A comprises a paper temperature setting unit 134A instead of the paper temperature setting unit 134 shown in FIG. 6. The paper temperature setting unit 134A sets a target value of the first paper temperature, which is the temperature of the paper S in a case of entering the first pre-coating device 15.

The control device 100A comprises a first moisture content sensor 140A instead of the first moisture content sensor 140 shown in FIG. 6. The first moisture content sensor 140A shown in FIG. 13 is disposed at or in the vicinity of an inlet of the first pre-coating device 15 for the paper S, and detects the first moisture content which is the moisture content of the paper S in a case of entering the first pre-coating device 15.

The control device 100A comprises a second moisture content sensor 142A instead of the second moisture content sensor 142 shown in FIG. 6. The second moisture content sensor 142A shown in FIG. 13 is disposed at or in the vicinity of an inlet of the second pre-coating device 21 for the paper S, and detects the second moisture content which is the moisture content of the paper S in a case of entering the second pre-coating device 21.

The control device 100A comprises a first paper temperature sensor 150A instead of the first paper temperature sensor 150 shown in FIG. 6. The first paper temperature sensor 150A shown in FIG. 13 is disposed at or in the vicinity of the inlet of the first pre-coating device 15 for the paper S, and detects the first paper temperature which is the temperature of the paper S in a case of entering the first pre-coating device 15.

The control device 100A comprises a second paper temperature sensor 152A instead of the second paper temperature sensor 152 shown in FIG. 6. The second paper temperature sensor 152A shown in FIG. 13 is disposed at or in the vicinity of the inlet of the second pre-coating device 21 for the paper S, and detects the second paper temperature which is the temperature of the paper S in a case of entering the second pre-coating device 21.

### [Example of Hardware Configuration of Control Device Applied to Ink Jet Printing System]

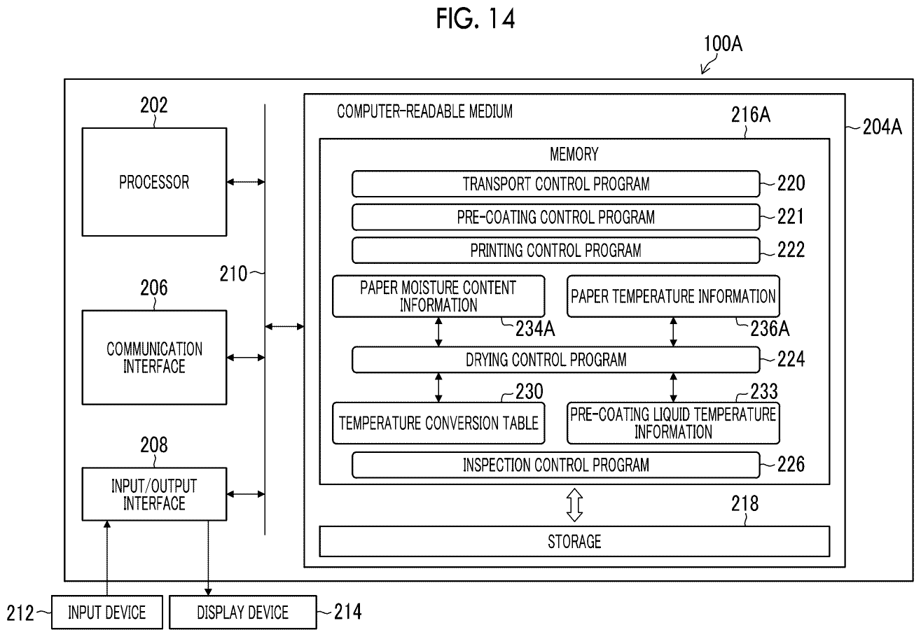

FIG. 14 is a block diagram schematically showing an example of a hardware configuration of the electric configuration shown in FIG. 13. The control device 100A shown in FIG. 14 is configured by adding a pre-coating control program 221, which is stored in a memory 216A of a computer-readable medium 204A, to the control device 100 shown in FIG. 7.

The drying control program 224 refers to paper moisture content information 234A including the first moisture content and the second moisture content.

In addition, the drying control program 224 refers to paper temperature information 236A including the first paper temperature and the second paper temperature.

Further, the drying control program 224 refers to pre-coating liquid temperature information 233 including the temperature of the pre-coating liquid supplied to the first pre-coating device 15. The drying control program 224 may refer to the temperature conversion table 230.

### [Procedure of Printing Method According to Second Embodiment]

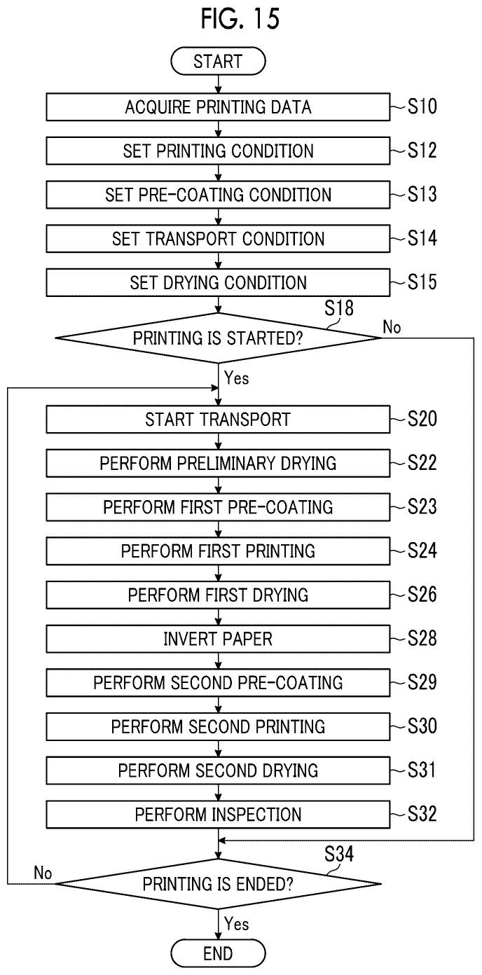

FIG. 15 is a flowchart showing a procedure of a printing method applied to the ink jet printing system shown in FIG. 12. In the procedure of the printing method shown in FIG. 15, a drying condition setting step S15 is executed instead of the drying condition setting step S16 of the procedure of the printing method shown in FIG. 8.

The drying condition setting step S15 is executed after the transport condition setting step S14. In the drying condition setting step S15, the preliminary drying control unit 104 sets the preliminary drying conditions applied to the preliminary drying device 14. In addition, in the drying condition setting step S15, the main drying control unit 108 sets the first drying conditions applied to the first drying device 18 and the second drying conditions applied to the second drying device 24. After the drying condition setting step S15, the process proceeds to the printing start determination step S18. The details of the drying condition setting step S15 will be described below.

The procedure of the printing method shown in FIG. 15 is configured by adding a pre-coating condition setting step S13, a first pre-coating step S23, and a second pre-coating step S29 to the procedure of the printing method shown in FIG. 8. The pre-coating condition setting step S13 is executed after the printing condition setting step S12 and before the transport condition setting step S14. The first pre-coating step S23 is executed after the preliminary drying step S22 and before the first printing step S24. The second pre-coating step S29 is executed after the paper inverting step S28 and before the second printing step S30.

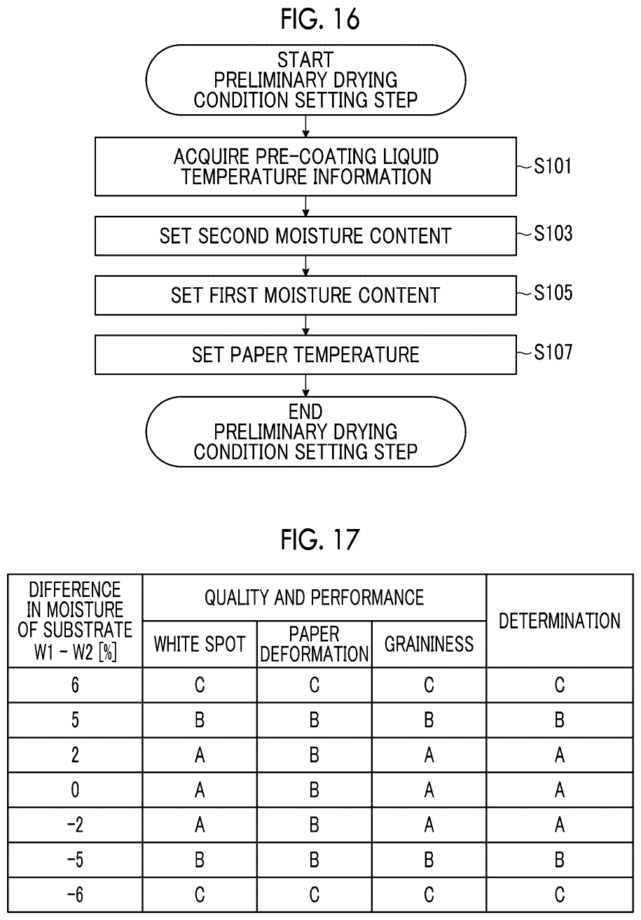

FIG. 16 is a flowchart showing a procedure of the preliminary drying condition setting step shown in FIG. 15. FIG. 16 shows a procedure of a preliminary drying condition setting step of setting the preliminary drying conditions applied to the preliminary drying device 14 shown in FIG. 12 in the drying condition setting step shown in FIG. 15.

In the preliminary drying condition setting step shown in FIG. 16, a pre-coating liquid temperature information acquisition step S101 is executed instead of the ink temperature information acquisition step S100 of the preliminary drying condition setting step shown in FIG. 9.

In the pre-coating liquid temperature information acquisition step S101, the pre-coating liquid temperature information acquisition unit 130A shown in FIG. 13 acquires pre-coating liquid temperature information including the temperature of the pre-coating liquid supplied to the first pre-coating device 15.

In the preliminary drying condition setting step shown in FIG. 16, a second moisture content setting step S103 of setting the target value of the second moisture content is executed instead of the second moisture content setting step S102 of the preliminary drying condition setting step shown in FIG. 9.

In the preliminary drying condition setting step shown in FIG. 16, a first moisture content setting step S105 of setting the target value of the first moisture content is executed instead of the first moisture content setting step S104 of the preliminary drying condition setting step shown in FIG. 9.

For the first moisture content, as in the first moisture content setting step S104 of the preliminary drying condition setting step shown in FIG. 9, in a case in which the second moisture content is set to W2 percent, a first moisture content W1 is set to a range of plus or minus 5.0% with respect to the second moisture content W2. The first moisture content W1 is more preferably in a range of plus or minus 2.0% with respect to the second moisture content W2.

In the preliminary drying condition setting step shown in FIG. 16, a paper temperature setting step S107 of setting the target value of the first paper temperature is executed instead of the paper temperature setting step S106 of the preliminary drying condition setting step shown in FIG. 9.

In a case in which the temperature of the pre-coating liquid supplied to the first pre-coating device 15 is denoted by TP, the first paper temperature TW° C. is set to a range satisfying 5.0° C.<TW° C.<TP° C.

The printing method showing the procedure shown in FIG. 15 and the preliminary drying condition setting step showing the procedure shown in FIG. 16 can be understood as a paper state adjustment method for adjusting the paper state. The paper state adjustment method described in the embodiment is an example of a substrate state adjustment method.

### Effect of Second Embodiment

The ink jet printing system 10A and the like according to the second embodiment can obtain the following effects.

[1]

The excess moisture contained in the paper S is reduced and adjusted to a preferred moisture content of the paper S before the paper S enters the first pre-coating device 15 where the pre-coating liquid is first applied to the paper S. As a result, the first drying device 18 can have a minimum drying ability required for the drying treatment of the front surface SA of the paper S to which the pre-coating liquid and the ink have been applied, and can achieve the reduction in size and the suppression of the cost of the first drying device 18.

In addition, the second drying device 24 can also have a minimum drying ability required for the drying treatment of the back surface SB of the paper S to which the ink has been applied, and can achieve the reduction in size and the suppression of the cost.

[2]

In the first drying device 18, generation of excess heat energy is suppressed. As a result, the drying of the ink jet head 40 caused by the thermal energy released from the first drying device 18 is suppressed. Drying of the ink inside the nozzle 62 and adhesion of a solidified substance of the ink to the vicinity of the nozzle opening 64 are suppressed, and occurrence of a fatal failure of the ink jet head 40, such as jetting failure, is suppressed. In the second drying device 24 as well, as with the first drying device 18, the generation of excess heat energy is suppressed, and the occurrence of the problem caused by the heat energy released from the second drying device 24 is suppressed.

[3]

The moisture content and the temperature of the paper S are optimized before the paper S enters the first pre-coating device 15 where the pre-coating liquid is first applied to the paper S. As a result, the occurrence of the unevenness of the pre-coating liquid on the paper S is suppressed, thereby ensuring the specified printed image quality.

[4]

Fluctuations in the printing environment, such as temperature and humidity fluctuations due to the seasonal variation and the weather, are suppressed. As a result, the temperature fluctuation, the humidity fluctuation, and the like of the paper S caused by the fluctuations in the printing environment are suppressed, and the fluctuation in the quality of the printed image is suppressed.

[5]

In a case in which the paper S has a relatively high moisture content, the pre-coating liquid permeates the paper S relatively slowly, and there is a concern that the unevenness of the pre-coating liquid occurs. On the other hand, in a case in which the moisture content and the temperature of the paper S are optimized, the unevenness of the pre-coating liquid is suppressed, and particularly, the deterioration in the quality of the printed image due to the deterioration of the graininess of the printed image can be suppressed.

[6]

In the double-sided printing, the first moisture content W1 is adjusted according to the second moisture content W2. Specifically, the first moisture content W1 is adjusted to a range of plus or minus 5.0% of the second moisture content W2. In addition, the first paper temperature TW is adjusted according to the pre-coating liquid temperature TP. Specifically, the first paper temperature TW is set to a range of 5.0° C.<TW° C.<TP° C. As a result, a quality difference in the printed image between the front surface SA of the paper S and the back surface SB of the paper S can be suppressed. In particular, in a case in which a booklet, a direct mail, or the like is created by folding a double-sided printed material, a value of ensuring that the quality of the printed image on the front surface SA of the paper S and the back surface SB of the paper S adjacent to each other is consistent is great.

The pre-coating liquid described in the embodiment is an example of a pretreatment liquid, and the first pre-coating device 15 is an example of a pretreatment liquid application device. The pre-coating liquid temperature TP described in the embodiment is an example of the temperature of the chemical liquid, and is an example of the temperature of the pretreatment liquid.

### [Evaluation of Moisture Content of Paper]

Evaluation results of the moisture content of the paper S are shown below. The preliminary drying was performed by changing control parameters of the preliminary drying device 14 shown in FIG. 1, an image for evaluation was printed, drying treatment in which a specified condition is applied to the image for evaluation was performed, and a state of the image for evaluation and a state of the paper S were visually evaluated. As the printed image for evaluation, a solid black image that is easy to visually recognize image defects was used. An area coverage of the solid image was set to 100%.

Various settings of the ink jet printing system 10 were set to initial values set in advance in the ink jet printing system 10 as conditions applied to general printing. An environmental temperature of the ink jet printing system 10 was set to 10° C. or higher and 30° C. or lower.

FIG. 17 is a table showing a relationship between a difference in moisture content of paper, quality of a printed image, and transport performance of paper. A substrate of the table shown in FIG. 17 represents the paper S. The first moisture content W1 and the second moisture content W2 of the paper S were measured using a near-infrared moisture meter. As the near-infrared moisture meter, for example, KB-30 manufactured by Kett Electric Laboratory Co. Ltd. can be used.

The first moisture content W1 was measured using the first moisture content sensor 140 provided in the first printing device 16, and the second moisture content W2 was measured using the second moisture content sensor 142 provided in the second printing device 22.

White spots in FIG. 17 indicate point-like image defects. Paper deformation indicates a state of crease of the paper S, such as waviness. Graininess represents whether or not a dot shape has a specified circular shape. Evaluation A represents good quality. Evaluation B represents that quality is inferior to that of Evaluation A but is within an allowable range. Evaluation C represents quality outside an allowable range. The determination was made based on the overall evaluation of the white spots, the paper deformation, and the graininess.

In a case in which a moisture content difference obtained by subtracting the second moisture content W2 from the first moisture content W1 is 6% and in a case in which the moisture content difference is −6%, all of the white spots, the paper deformation, and the graininess were evaluated as C, and the determination was evaluated as C.

In a case in which the moisture content difference is 5% and in a case in which the moisture content difference is −5%, all of the white spots, the paper deformation, and the graininess were evaluated as B, and the determination was evaluated as B. That is, in a case in which the moisture content difference is −5% or more and 5% or less, the quality of the printed image and the state of the paper S satisfy the specified quality.

In a case in which the moisture content difference is 2%, in a case in which the moisture content difference is −2%, and in a case in which the moisture content difference is 0%, the white spots and the graininess were evaluated as A, the paper deformation was evaluated as B, and the determination was evaluated as A. That is, in a case in which the moisture content difference is within plus or minus 2%, the quality of the printed image and the state of the paper S are also good.

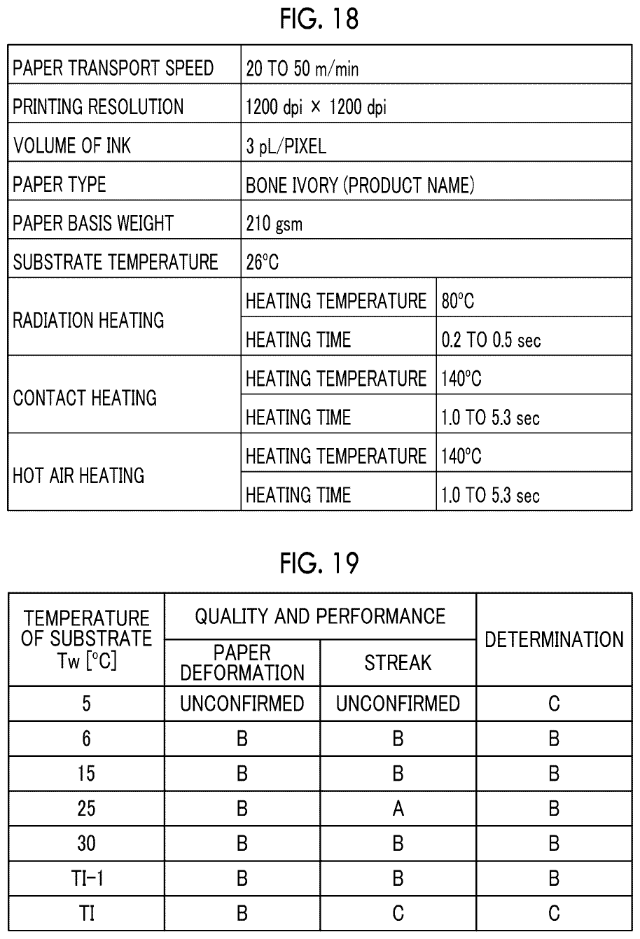

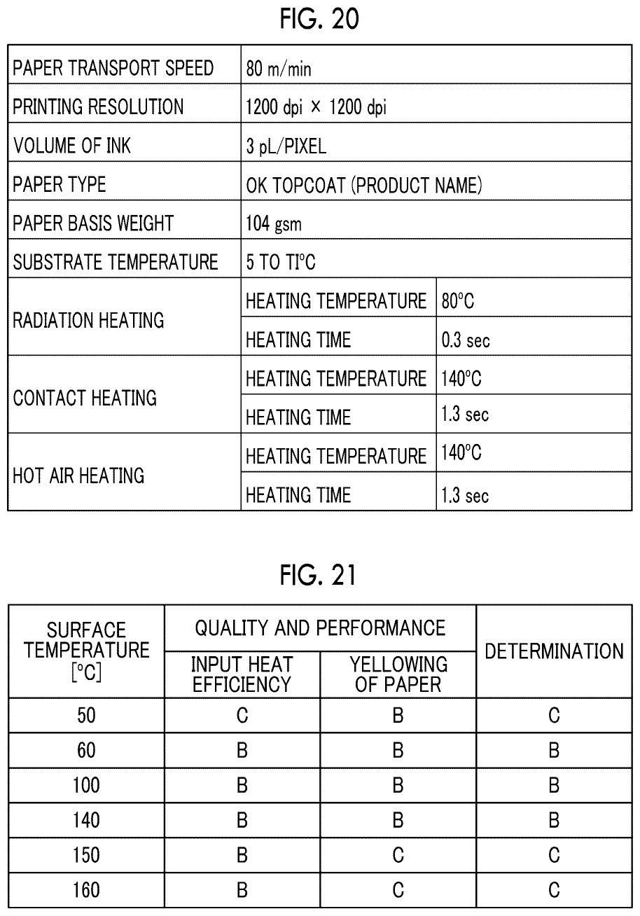

FIG. 18 is a table showing conditions for carrying out an evaluation experiment from which the table shown in FIG. 17 is derived. FIG. 18 shows settings of a paper transport speed, a printing resolution, a volume of an ink liquid droplet per pixel, a type of paper, and a thickness of paper as the printing conditions. In FIG. 18, the volume of the ink liquid droplet per pixel is described as an ink amount, and the thickness of the paper is described as a paper basis weight. The same applies to FIGS. 20, 22, and 24.

The paper transport speed was adjusted in a range of 20 meters per minute to 50 meters per minute according to a heating time, the printing resolution was set to 1200 dots per inch in both the paper transport direction and the paper width direction, and the volume of the ink liquid droplet per pixel was set to 3 picoliters. In addition, Bone Ivory was used as the paper, and the paper basis weight representing the thickness of the paper was 210 grams per square meter. Bone Ivory is a product name of Ojimateria Co., Ltd.

FIG. 18 shows a temperature of the paper, and a heating temperature and a heating time for each of radiation heating, contact heating, and hot air heating as the heating conditions. In FIG. 18, the temperature of the paper is described as a substrate temperature. The same applies to FIGS. 20, 22, and 24.

The temperature of the paper was set to 26° C., the heating temperature of the radiation heating was set to 80° C., and the heating time of the radiation heating was appropriately adjusted in a range of 0.2 seconds to 0.5 seconds to achieve a target moisture content. In a case of the radiation heating, the heating temperature was the surface temperature of the paper.

In a case of the contact heating and the hot air heating, the heating temperature was 140° C., and the heating time was appropriately adjusted in a range of 1.0 second to 5.3 seconds to achieve a target moisture content. The conditions of the evaluation experiment shown in FIG. 18 are not typical as printing conditions and drying conditions in an ink jet printing system, and are conditions that can be generally widely applied. That is, the evaluation results shown in FIG. 17 have general-purpose properties in an ink jet printing system for a graphic application on paper. The same applies to evaluation results shown in FIGS. 19, 21, and 23 below.

### [Evaluation of Temperature of Paper]

The temperature of the paper S was evaluated using the same device as that used for the evaluation of the moisture content of the paper S described above. Results of the temperature evaluation of the paper S are shown below. FIG. 19 is a table showing a relationship between a difference in temperature of paper, quality of a printed image, and transport performance of the paper. A substrate of the table shown in FIG. 19 represents the paper S.

The temperature of the paper S was measured using the first paper temperature sensor 150 provided in the first printing device 16 for the paper S whose temperature was adjusted using the preliminary drying device 14.

In a case in which the temperature of the paper S was 5.0° C., 6.0° C., 15° C., 25° C., 30° C., the ink temperature TI−1° C., and the ink temperature TI° C., the deformation of the paper S and the quality of the printed image were visually evaluated. The quality of the printed image was evaluated from the viewpoint of occurrence of streaks in the printed image. Evaluation A represents good, Evaluation B represents fair, and Evaluation C represents poor. The ink temperature TI was set to 32° C. or 35° C.

In a case in which the temperature of the paper S was 6° C., 15° C., 25° C., and 30° C., the paper deformation was evaluated as B. Even in a case in which the temperature of the paper S was the ink temperature TI−1° C. and the ink temperature TI° C., the paper deformation was evaluated as B. In a case in which the temperature of the paper S was 6° C., 15° C., 30° C., and the ink temperature TI−1° C., the quality of the printed image was evaluated as B. In a case in which the temperature of the paper S was 25° C., the quality of the printed image was evaluated as A.

On the other hand, in a case in which the temperature of the paper S was 5° C., neither the paper deformation nor the image quality was confirmed. In addition, in a case in which the temperature of the paper S was the ink temperature TI, the paper deformation was evaluated as C, the image quality was evaluated as B, and the determination was evaluated as C. That is, in a case in which the first paper temperature TW exceeded 5.0° C. and was lower than the ink temperature TI, the determination was evaluated as B, and a preferable state of the paper S and preferable quality of the printed image were achieved.

FIG. 20 is a table showing conditions for carrying out an evaluation experiment from which the table shown in FIG. 19 is derived. Items of the printing conditions and items of the drying conditions shown in FIG. 20 are the same as the implementation conditions of the evaluation experiment shown in FIG. 18. In the printing conditions shown in FIG. 20, the paper transport speed was 80 meters per minute, the printing resolution was 1200 dots per inch in both the paper transport direction and the paper width direction, and the volume of the ink liquid droplet per pixel was 3 picoliters. In addition, OK topcoat was used as the paper, and the paper basis weight representing the thickness of the paper was 104 grams per square meter. OK topcoat is a product name of Oji Paper Co., Ltd.

In addition, in the heating conditions shown in FIG. 20, the temperature of the paper was adjusted to the temperature value shown in FIG. 19 in a range of 5° C. to the ink temperature TI° C., the heating temperature of the radiation heating was 80° C., and the heating time was 0.3 seconds. In a case of the contact heating and the hot air heating, the heating temperature was 140° C. and the heating time was 1.3 seconds.

### [Evaluation of Control Parameter of Preliminary Drying Device]

Next, evaluation results obtained by evaluating the control parameters applied to the preliminary drying device 14 from the viewpoint of thermal efficiency and the viewpoint of the state of the paper S will be described. In the evaluation experiment, the operation was performed under the same conditions as in the evaluation of the moisture content of the paper S described above, using the ink jet printing system 10 shown in FIG. 1.

The control parameter applied to the preliminary drying device 14 was the surface temperature of the heat roller 32 shown in FIG. 2. The viewpoints of the evaluation were the thermal efficiency and the state of the paper S. The thermal efficiency was evaluated by visual observation of the drying state of the paper S. The state of the paper S was evaluated by visual observation of the presence or absence of yellowing of the paper S. As the heat roller temperature sensor 33 that measures the surface temperature of the heat roller 32, a radiation temperature sensor FT series manufactured by KEYENCE CORPORATION was used.

FIG. 21 is a table showing a relationship between a difference in surface temperature of the heat roller, quality of a printed image, and transport performance of paper. In a case in which the surface temperature of the heat roller 32 was 50° C., the state of the paper S was evaluated as B, the thermal efficiency was evaluated as C, and the overall determination of the thermal efficiency and the state of the paper S was evaluated as C. In addition, in a case in which the surface temperature of the heat roller 32 was 150° C. and in a case in which the surface temperature of the heat roller 32 was 160° C., the thermal efficiency was evaluated as B, the state of the paper S was evaluated as C, and the overall determination of the thermal efficiency and the state of the paper S was evaluated as C.

On the other hand, in a case in which the surface temperature of the heat roller 32 was 60° C., 100° C., and 140° C., the thermal efficiency and the state of the paper S were evaluated as B, and the overall determination of the thermal efficiency and the state of the paper S was evaluated as B. That is, in a case in which the surface temperature of the heat roller 32 is applied as the control parameter of the preliminary drying device 14, the surface temperature of the heat roller 32 can be set to 60° C. or higher and 140° C. or lower.

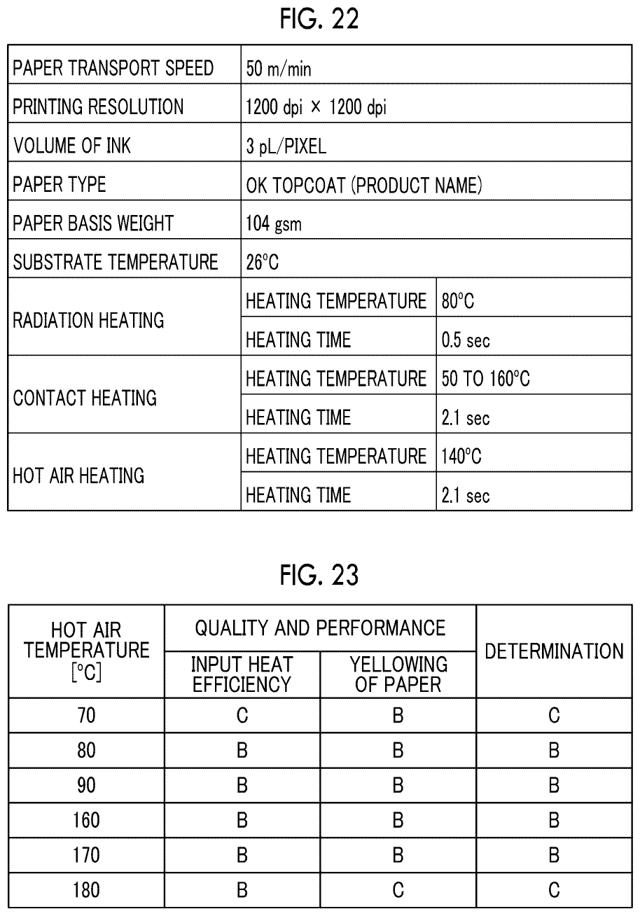

FIG. 22 is a table showing conditions for carrying out an evaluation experiment from which the table shown in FIG. 21 is derived. Items of the printing conditions and items of the drying conditions shown in FIG. 22 are the same as the implementation conditions of the evaluation experiment shown in FIG. 18 and the like. In the printing conditions shown in FIG. 22, the paper transport speed was 50 meters per minute, the printing resolution was 1200 dots per inch in both the paper transport direction and the paper width direction, and the volume of the ink liquid droplet per pixel was 3 picoliters. In addition, OK topcoat was used as the paper, and the paper basis weight representing the thickness of the paper was 104 grams per square meter.

In addition, in the heating conditions shown in FIG. 22, the temperature of the paper was 26° C., the heating temperature of the radiation heating was 80° C., and the heating time was 0.5 seconds. In a case of the contact heating, the heating temperature was adjusted to the temperature value shown in FIG. 21 in a range of 50° C. to 160° C., and the heating time was set to 2.1 seconds. In a case of the hot air heating, the heating temperature was 140° C. and the heating time was 2.1 seconds.

FIG. 23 is a table showing a relationship between a difference in hot air temperature, quality of a printed image, and transport performance of paper S. The hot air temperature is a temperature of convection released from the fan 34 shown in FIG. 2. The temperature on the paper S of the convection released from the fan 34 was actually measured as the hot air temperature. A radiation temperature sensor FT series manufactured by KEYENCE CORPORATION was used for measuring the hot air temperature.

In a case in which the hot air temperature was 70° C., the state of the paper S was evaluated as B, the thermal efficiency was evaluated as C, and the overall determination of the thermal efficiency and the state of the paper S was evaluated as C. In addition, in a case in which the hot air temperature was 180° C., the thermal efficiency was evaluated as B, the state of the paper S was evaluated as C, and the overall determination of the thermal efficiency and the state of the paper S was evaluated as C.

On the other hand, in a case in which the hot air temperature was 80° C., 90° C., 160° C., and 170° C., the thermal efficiency and the state of the paper S were evaluated as B, and the overall determination of the thermal efficiency and the state of the paper S was evaluated as B. That is, in a case in which the hot air temperature is applied as the control parameter of the preliminary drying device 14, the hot air temperature can be set to 80° C. or higher and 170° C. or lower.

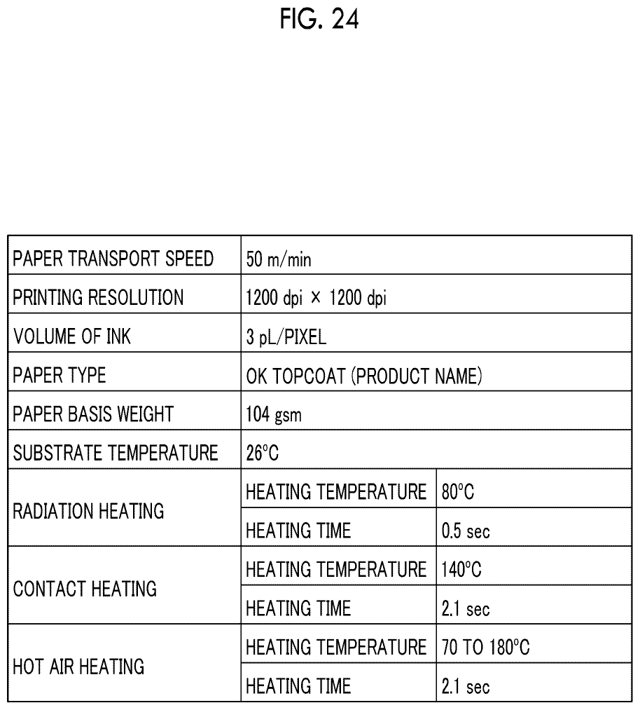

FIG. 24 is a table showing conditions for carrying out an evaluation experiment from which the table shown in FIG. 23 is derived. Items of the printing conditions and items of the drying conditions shown in FIG. 24 are the same as the implementation conditions of the evaluation experiment shown in FIG. 18 and the like. In the printing conditions shown in FIG. 24, the paper transport speed was 50 meters per minute, the printing resolution was 1200 dots per inch in both the paper transport direction and the paper width direction, and the volume of the ink liquid droplet per pixel was 3 picoliters. In addition, OK topcoat was used as the paper, and the paper basis weight representing the thickness of the paper was 104 grams per square meter.

In addition, in the heating conditions shown in FIG. 24, the temperature of the paper was 26° C., the heating temperature of the radiation heating was 80° C., and the heating time was 0.5 seconds. In a case of the contact heating, the heating temperature was 140° C. and the heating time was set to 2.1 seconds. In a case of the hot air heating, the heating temperature was adjusted to the temperature value shown in FIG. 23 in a range of 70° C. to 180° C., and the heating time was 2.1 seconds.

The evaluation results described above can also be applied to the ink jet printing system 10A described with reference to FIGS. 12 to 16. The reason is that both the preliminary drying device 14 and the first drying device 18 shown in FIG. 12 evaporate the moisture contained in the front surface SA and the inside of the paper S to achieve a specified drying state.

### [Disposition of Preliminary Drying Device]

The preliminary drying device 14 shown in FIG. 1 is disposed to avoid a portion below the first printing device 16. The portion below the first printing device 16 is a position on a side to which a vertical direction of the first printing device 16 is directed, and is, for example, a region denoted by reference numeral 16A using a two-dot chain line in FIG. 1.

In a case in which the preliminary drying device 14 is disposed in the portion 16A below the first printing device 16, heat released from the preliminary drying device 14 reaches the first printing device 16, and there is a concern that jetting failure of the ink jet head 40 provided in the first printing device 16 occurs. Therefore, it is preferable that the preliminary drying device 14 is disposed at a position that is aligned with the first printing device 16 in the paper transport direction and that is higher than a lowermost end of the first printing device 16 in a height direction while avoiding the portion 16A below the first printing device 16.

The position that is aligned with the first printing device 16 in the paper transport direction may include a portion below the preliminary drying device 14 shown in FIG. 1. The height direction is a direction orthogonal to the paper transport direction and is a direction parallel to the vertical direction.

For the preliminary drying device 14 shown in FIG. 12 as well, it is preferable that the preliminary drying device 14 is disposed at a position aligned with the first pre-coating device 15 in the paper transport direction while avoiding the portion below the first pre-coating device 15.

### [Problems in Double-Sided Printing on Thin Paper]

In the related art, in a case in which double-sided printing is performed on thin paper, printing is performed on a front surface and drying treatment is performed. Next, printing is performed on a back surface, and drying treatment is performed. There are the following problems in the double-sided printing on the thin paper. Here, the thin paper can be specified as a medium having a basis weight of 127 grams per square meter or less.

### [Problems Regarding Front and Back Registration]

Due to volatilization of moisture in the paper during the drying treatment for the front surface, the paper shrinks, and, in a case of performing printing on the back surface, a size of the paper is reduced than in a case of printing on the front surface. In particular, the shrinkage of the paper S is remarkable in the paper width direction orthogonal to a grain direction of the paper.

In the printing on the back surface, in a case in which an image of the same area is printed as on the front surface, an area of the printed image on the back surface is larger than an area of the printed image on the front surface due to the shrinkage of the paper. In this case, so-called problems regarding front and back registration occur, such as a problem in that the area of the printed image is different between the front surface and the back surface and a problem in that the position of the printed image is different between the front surface and the back surface.

In the related art, correction using image processing, such as increasing the printed image on the back surface with respect to the printed image on the front surface, is known for the problem regarding the front and back registration. However, in a case in which the amount of correction is relatively large, there is a concern that the image quality deteriorates.

### [Problems Regarding Head Rubbing]

An image area on the paper in which the image is printed expands due to permeation of moisture contained in the ink into a pulp layer. On the other hand, in a case in which the drying is performed sufficiently strongly for the purpose of obtaining sufficient film hardness in the image area and suppressing picking, the moisture of the paper itself is excessively volatilized. In this case, the non-image area in which the image is not printed excessively shrinks, causing the expansion and shrinkage amount of the image area to differ from the expansion and shrinkage amount of the non-image area, resulting in distortion between the image area and the non-image area. As a result, crease occurs and cockle becomes worse.

In a case in which printing is performed on the back surface, in a case where a height of the remaining crease and cockle exceeds a distance between the head and the paper, there is a problem in that the paper comes into contact with the head, making it difficult to perform normal printing. Hereinafter, a substrate state adjustment method applied to the ink jet printing system 10 that solves the above-described problems will be described.

### [Specific Example of Substrate State Adjustment Method]

In a case in which double-sided printing is performed, the ink jet printing system 10 according to the embodiment performs drying treatment on the front surface SA of the paper S before printing, adjusts the moisture content of the paper S itself, and adjusts the temperature of the paper S.

Next, printing is performed on the front surface SA of the paper S, and the front surface SA of the paper S is subjected to drying treatment. Further, the front surface SA and the back surface SB of the paper S are inverted, printing is performed on the back surface SB of the paper S, and drying treatment is performed on the back surface SB of the paper S.

With respect to the problem regarding the front and back registration caused by the expansion and shrinkage of the paper S, the paper S has already shrunk during the printing on the front surface SA and the printing on the back surface SB due to the shrinkage of the paper S subjected to the preliminary drying, and the excessive shrinkage of the paper S caused by the main drying after printing is suppressed. As a result, the shrinkage of the paper S is suppressed to a minimum.

That is, the ink jet printing system 10 in which the paper S before printing is preliminarily dried can relatively reduce a difference in the size of the paper S in a case where printing is performed on the back surface SB relative to the size of the paper S in a case in which printing is performed on the front surface SA, as compared with a case in which the paper S before printing is not preliminarily dried. This makes it possible to perform front and back registration without performing correction for the front and back registration or by performing correction for the front and back registration. An evaluation test regarding the shrinkage of the paper S will be described below.

### [Evaluation Test Regarding Expansion and Shrinkage of Paper]

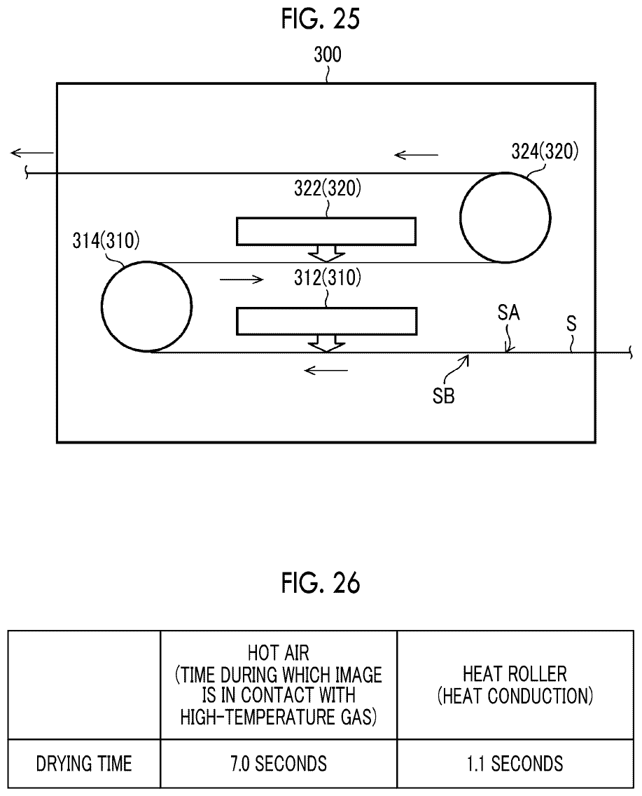

FIG. 25 is a schematic configuration diagram of a preliminary drying device used in an evaluation test regarding expansion and shrinkage of paper. A drying device 300 shown in FIG. 25 comprises a first drying device 310 that performs drying treatment on the front surface SA of the paper S and a second drying device 320 that performs drying treatment on the back surface SB of the paper S.

The first drying device 310 comprises a first hot air jetting device 312 that jets hot air to the front surface SA of the paper S and a first heat roller 314 that comes into contact with the front surface SA of the paper S. Similarly, the second drying device 320 comprises a second hot air jetting device 322 and a second heat roller 324.

The first hot air jetting device 312 and the second hot air jetting device 322 are provided with hot air jetting ports having a length corresponding to the entire length of the paper S in the paper width direction. In addition, the first heat roller 314 and the second heat roller 324 have a length corresponding to the entire length of the paper S in the paper width direction.

The drying device 300 comprises a transport device that applies a roller transport system to transport the continuous form paper S. In FIG. 25, an arrow line shown in the vicinity of the paper S represents a transport direction of the paper S. In addition, arrow lines attached to the first hot air jetting device 312 and the second hot air jetting device 322 indicate jetting directions of the hot air. The transport device provided in the drying device 300 is not shown.

FIG. 25 shows an example of the drying device 300 comprising one first drying device 310 and one second drying device 320, but a plurality of the first drying devices 310 and a plurality of the second drying devices 320 may be provided. For example, the plurality of first drying devices 310 and the plurality of second drying devices 320 may be connected in series alternately to expand an ability to adjust the drying intensity for the paper S.

The first drying device 310 described in the embodiment is an example of a component of a first moisture content adjustment device. The first heat roller 314 described in the embodiment is an example of a first heat conduction member. The first hot air jetting device 312 described in the embodiment is an example of a first air blowing device.

The second drying device 320 described in the embodiment is an example of a component of a second moisture content adjustment device. The second heat roller 324 described in the embodiment is an example of a second heat conduction member. The second hot air jetting device 322 described in the embodiment is an example of a second air blowing device.

FIG. 26 is a table showing drying conditions applied to an evaluation test regarding expansion and shrinkage of paper. Hot air shown in the table of FIG. 26 indicates drying treatment in which the first hot air jetting device 312 is used or drying treatment in which the second hot air jetting device 322 is used. In addition, a heat roller shown in the table of FIG. 26 indicates drying treatment in which the first heat roller 314 is used or drying treatment in which the second heat roller 324 is used. A drying time represents a time during which one image printed on the paper S is in contact with a high-temperature gas and a time during which one image printed on the paper S is in contact with the first heat roller 314 and the second heat roller 324 and receives heat conduction.

In the evaluation test regarding the expansion and shrinkage of the paper S, a hot air drying time was set to 7.0 seconds for both the front surface SA of the paper S and the back surface SB of the paper S, and a heat roller drying time in the same evaluation test was set to 1.1 seconds for both the front surface SA of the paper S and the back surface SB of the paper S.

The hot air drying time was determined by a length of a hot air outlet in the paper transport direction and a transport speed of the paper S. The heat roller drying time was determined by a length of the paper S in contact with the first heat roller 314 in the paper transport direction, a length of the paper S in contact with the second heat roller 324, and a transport speed of the paper S.

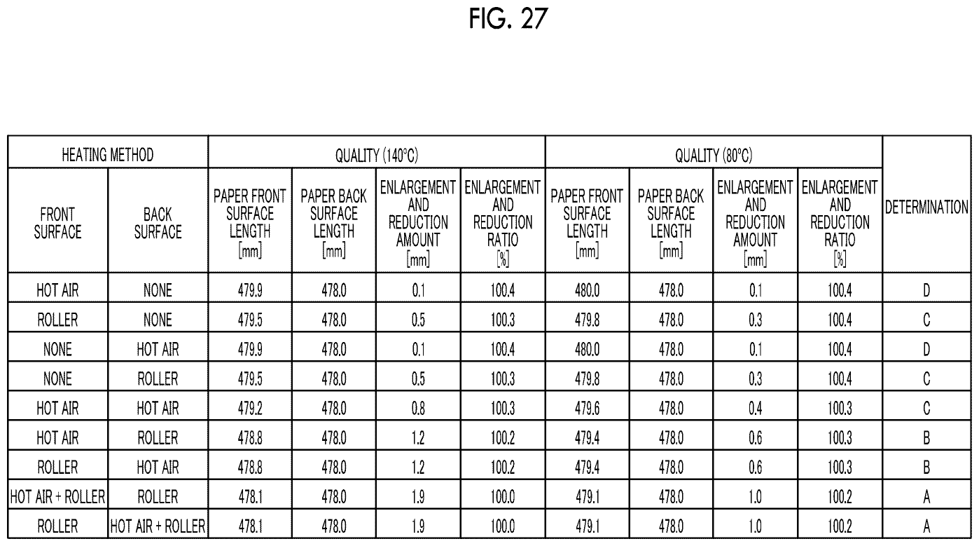

FIG. 27 is a table showing results of an evaluation test regarding expansion and shrinkage of paper. In the evaluation test regarding the expansion and shrinkage of the paper S, the enlargement and reduction amount and the enlargement and reduction ratio of the paper S were calculated in a case in which the surface temperature of the paper S was 140° C. and in a case in which the surface temperature of the paper S was 80° C. As the paper S, OK topcoat having a basis weight of 104 grams per square meter was used.

The column of the drying method shown in the table of FIG. 27 shows the drying method of each of the front surface SA of the paper S and the back surface SB of the paper S. The term “None” in the same column represents that the drying treatment was not performed. The hot air in the same column represents hot air drying. The roller in the same column represents heat roller drying. The hot air+roller in the same column represents that hot air drying and heat roller drying are used in combination.

The enlargement and reduction amount shown in the table of FIG. 27 is calculated by subtracting a paper front surface length, which is a size of the front surface SA of the paper S after preliminary drying, from a paper back surface length, which is a size of the back surface SB of the paper S after preliminary drying. The unit of the enlargement and reduction amount is millimeters.

A length in the paper width direction may be applied as the size of the front surface SA of the paper S and the size of the back surface SB of the paper S. As the length in the paper width direction, an average value of measurement values at a plurality of positions in the paper transport direction may be applied. A noncontact measurement device can be applied to the measurement of the size of the paper S.

The enlargement and reduction ratio shown in the table of FIG. 27 is a ratio of the paper front surface length to the paper front surface length after preliminary drying, and is expressed using a percentage. The unit of the enlargement and reduction ratio is percent.

Determination A shown in the table of FIG. 27 represents a state in which the paper S is enlarged or reduced to such an extent that correction of the front and back registration is not necessary. Determination B represents a state in which the paper S is enlarged or reduced to such an extent that relatively weak correction of the front and back registration is required. Determination C represents a state in which the paper S is enlarged or reduced to such an extent that relatively strong correction of the front and back registration is required but the front and back registration is possible. Determination D represents a state in which front and back registration is difficult to achieve even in a case in which correction of the front and back registration is performed.

In a case in which Determination A, Determination B, and Determination C are specified as the allowable range of the deformation of the paper S, and in a case in which at least the heat roller drying is performed for the preliminary drying on the front surface SA and the preliminary drying on the back surface SB, preferred preliminary drying is achieved in a case in which the temperature adjustment range is 80° C. or higher and 140° C. or lower from the viewpoint of the front and back resistance deviation. In addition, even in a case in which the hot air drying is performed for the preliminary drying on the front surface SA and the preliminary drying on the back surface SB, preferred preliminary drying is achieved in a case in which the temperature adjustment range is 80° C. or higher and 140° C. or lower from the viewpoint of the front and back registration deviation.

Further, in a case in which the combined use of the hot air drying and the heat roller drying is applied to any of the preliminary drying on the front surface SA of the paper S or the drying of the back surface SB of the paper S, more preferred preliminary drying is achieved.

### [Regarding Evaluation of Head Rubbing]

In a case in which the moisture in the ink permeates the pulp layer of the paper S, the pulp layer is less likely to swell in a case in which the preliminary drying is performed as compared with a case in which the preliminary drying is not performed. That is, in a case in which the preliminary drying is performed, the permeation allowance of the paper S is increased as compared with a case in which the preliminary drying is not performed. This is due to the fact that, as a result of the preliminary drying, moisture other than hydrogen bonds in the pulp layer of the paper S evaporates, and the moisture allowance of the pulp layer increases.

In this case, the paper S is less likely to expand in the image area of the paper S where the image is printed, and the paper S is less likely to shrink in the non-image area of the paper S where the image is not printed. As a result, the paper S is not distorted, the occurrence of crease and the occurrence of cockle are remarkably suppressed, and the head rubbing in which the paper S collides with the ink jet head 49K or the like shown in FIG. 3 is avoided. The drying method shown in FIG. 27 is also effective in avoiding the head rubbing.

[Problems of Radiation Drying Treatment after Printing]

In the related art, it is common to perform radiation drying on the paper after printing, but, in high-speed printing, it is difficult to sufficiently increase the temperature of the surface of the paper on which printing has been performed and to obtain sufficient strength of the ink film. In particular, the above-described problems are remarkable in coated paper in which the ink permeation is relatively slow.

On the other hand, in a case in which the intensity of the radiation drying is increased for the purpose of increasing the temperature of the surface of the paper on which printing is performed in a relatively short period, not only the moisture of the ink but also the moisture of the paper itself are excessively volatilized. As a result, the non-image area excessively shrinks, causing the expansion and shrinkage amount of the image area to differ from the expansion and shrinkage amount of the non-image area, resulting in distortion between the image area and the non-image area. As a result, the paper deformation such as crease and cockle becomes worse. For example, in a case of roll paper, cockle becomes worse, and, in a case of sheet paper, both cockle and curl become worse.

### [Evaluation Test of Paper Deformation Related to Radiation Drying]

In the ink jet printing system 10 according to the embodiment, it was found that in a case in which preliminary drying is performed before printing is performed on the paper S, printing is performed on the paper S in a state of being dried to some extent, and then the paper S is irradiated with an electromagnetic wave to dry the paper S, deformation of the paper S is remarkably improved. The reason is as follows.

In a case in which the preliminary drying is performed, an arrival temperature on the surface of the paper S, on which printing is performed, immediately after radiation drying is increased. In a case in which the preliminary drying is performed on the paper S before printing, the moisture content contained in the paper S is reduced, and the heat energy of the radiation drying is allocated to the temperature increase of the paper S itself. That is, it is possible to concentrate thermal energy on the heating of the ink film of the paper S.

Accordingly, the temperature of the surface of the paper S on which printing is performed and the temperature of the ink film on the surface of the paper S on which printing is performed can be increased in a relatively short time, the moisture derived from the ink can be volatilized before the moisture derived from the ink permeates the pulp layer of the paper S or in an initial stage of the permeation of the moisture derived from the ink into the pulp layer of the paper S, swelling of the pulp layer can be suppressed to a minimum, and as a result, deformation of the paper S can be remarkably suppressed.

In addition, in the ink jet printing system 10 according to the embodiment, the preliminary drying is performed before printing, and the radiation drying is performed after printing in a state in which the moisture of the paper S is reduced, so that even in a case in which the intensity of the radiation drying is increased in order to increase the temperature of the surface of the paper S on which printing is performed, the moisture itself volatilizing from the paper S is small. Therefore, the moisture of the paper S itself is not excessively volatilized, and the excessive shrinkage of the non-image area is avoided. Therefore, the deformation of the paper S can be prevented from being worse.

In summary, in the ink jet printing system 10 according to the embodiment, the radiation drying is performed in a state in which the moisture of the paper S itself is reduced, and the deformation of the paper S is remarkably suppressed as a synergistic effect of the reduction of the content of moisture permeating into the pulp layer due to the effect of increasing the temperature increase rate and the avoidance of the excessive shrinkage of the non-image area.

### [Configuration Example of Radiation Drying Device]

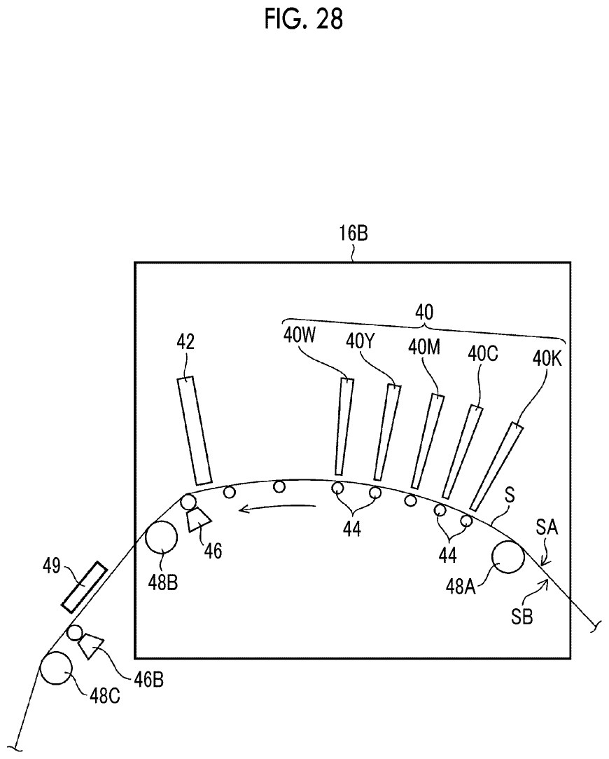

FIG. 28 is a configuration diagram of a first printing device, which shows a disposition example of a radiation drying device. FIG. 28 shows a first printing device 16B configured by adding a radiation drying device 49 to the first printing device 16 shown in FIG. 3. The radiation drying device 49 shown in FIG. 28 is disposed at a position further downstream of the ink jet head 40W on the most downstream side in the paper transport direction. The configuration of the first printing device 16B shown in FIG. 28 may be applied to the second printing device 22.

The radiation drying device 49 provided in the first printing device 16B described in the embodiment is an example of a first electromagnetic wave irradiation device, and the radiation drying device provided in the second printing device 22 is an example of a second electromagnetic wave irradiation device.

### [Results of Evaluation Test of Radiation Drying]

The moisture content of the paper S in a case in which the radiation drying using the radiation drying device 49 shown in FIG. 28 is started is preferably 6.0% or less. The moisture content of the paper S is more preferably 5.0% or less and still more preferably 4.0% or less.

### [Evaluation of Tension Applied to Paper]

On the other hand, in a case in which the moisture content of the paper S in a case of entering the radiation drying device 49 is less than 1.0%, the paper S is in an excessively dried state, and there is a concern that the paper S is damaged. In particular, in a case in which the paper S is continuous paper, the paper S is likely to be broken.

Regarding the above-described problem, in a case in which a posture of the paper S during the radiation drying is kept flat, deformation of the paper S is effectively suppressed in an initial stage of permeation of the ink into the paper S. In order to keep the posture of the paper S horizontal, a tension applied to the paper S is adjusted. In the radiation drying device 49 shown in FIG. 28, the tension applied to the paper S is adjusted by using a tension roller 48B and a tension roller 48C. The tension applied to the paper S is measured using a tension pickup 46B. The paper S shown in FIG. 28 is transported in a posture in which the flexure in a direction intersecting a transport surface of the paper S is minimized by using the tension roller 48B and the tension roller 48C. As a result, the deformation of the paper S caused by the flexure of the paper S is suppressed. The tension roller 48B and the tension roller 48C described in the embodiment are examples of components of a tension application device.

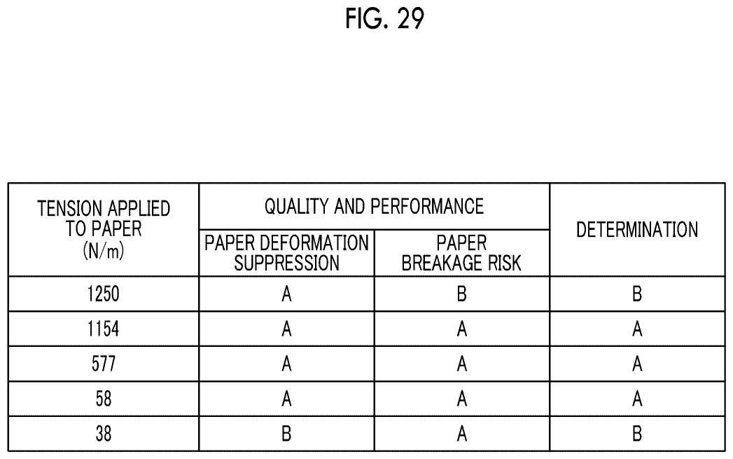

FIG. 29 is a table showing results of an evaluation test regarding a tension. In the evaluation test regarding the tension, the tension applied to the paper S was changed, and the drying treatment under the same drying conditions was performed to evaluate the quality and performance of the radiation drying. As the drying conditions, the paper S was subjected to radiation drying for 0.4 seconds in which the surface temperature of the paper S was set to 80° C. using the radiation drying device 49 shown in FIG. 28, and then subjected to hot air drying and contact heat transfer drying for 1.5 seconds in which the surface temperature of the paper S was set to 120° C. using the first drying device 18 shown in FIG. 1.

The viewpoint of the evaluation of the quality and performance of the radiation drying is the suppression of the deformation of the paper S and the risk of the breakage of the paper S. As an evaluation method, visual observation of the paper S after the radiation drying was applied. In FIG. 29, Evaluation A represents good, and Evaluation B represents inadequate.

The tension applied to the paper S was set to 38 newtons per meter, 58 newtons per meter, 577 newtons per meter, 1154 newtons per meter, and 1205 newtons per meter. For measuring the tension applied to the paper S, a tension sensor CJ1000 and a tension meter TM manufactured by NIRECO Corporation were used.

In a case in which the tension applied to the paper S is 58 newtons per meter or more, the deformation of the paper S is suppressed. In addition, in a case in which the tension applied to the paper S is 1154 newtons per meter or less, the risk of the breakage of the paper S is avoided.

That is, in a case in which the tension applied to the paper S is 58 newtons per meter or more and 1154 newtons per meter or less, the deformation of the paper S is suppressed, and the risk of the breakage of the paper S is avoided.

[Evaluation of Period from End of Ink Droplet Jetting to Start of Radiation Drying]

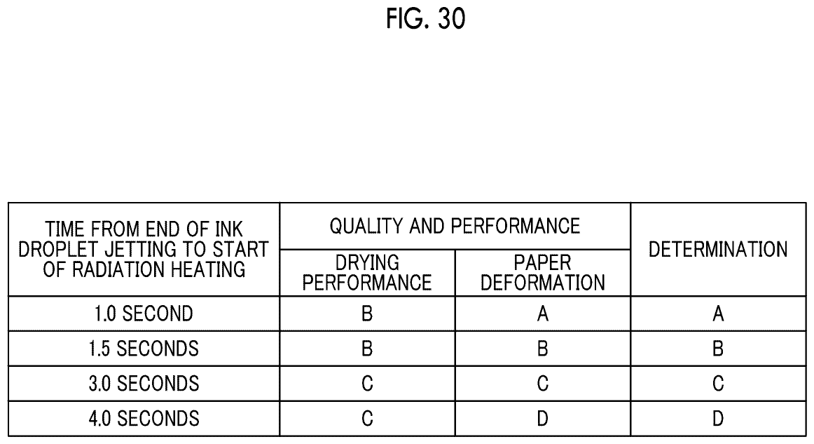

FIG. 30 is a table showing results of an evaluation test regarding a time from end of ink droplet jetting to start of radiation drying. As an end timing of the ink droplet jetting, a timing at which a drying target portion of the paper S passes through a printing region of the ink jet head 40W shown in FIG. 28 was applied. In addition, as a timing of the start of the radiation drying, a timing at which the drying target portion of the paper S reaches a drying region of the radiation drying device 49 was applied.

The viewpoint of the evaluation of the quality and performance of the radiation drying is the drying performance and the deformation of the paper S. As an evaluation method, visual observation of the paper S after the radiation drying was applied. As a time from the end of the ink droplet jetting to the start of the radiation heating, 1.0 second, 1.5 seconds, 3.0 seconds, and 4.0 seconds were applied. A drying temperature and a drying time are the same as those in the evaluation test of the tension applied to the paper S described above.

In FIG. 30, Evaluation A represents good performance. Evaluation B represents performance that is inferior to Evaluation A but is within an allowable range. Evaluation C represents performance that is inferior to Evaluation B but is within an allowable range under the condition. Evaluation D represents performance outside an allowable range.

Regarding the drying performance, in a case in which the time from the end of the ink droplet jetting to the start of the radiation heating is 4.0 seconds or less and in a case in which the time is 3.0 seconds or less, the drying performance in an allowable range is obtained. In a case in which the time from the end of the ink droplet jetting to the start of the radiation heating is 1.5 seconds or less, good drying performance is obtained. Further, in a case in which the time from the end of the ink droplet jetting to the start of the radiation heating is 1.0 second or less, the best drying performance is obtained.

Regarding the deformation of the paper S, in a case in which the time from the end of the ink droplet jetting to the start of the radiation heating is 3.0 seconds or less, the deformation of the paper S falls within an allowable range. In a case in which the time from the end of the ink droplet jetting to the start of the radiation heating is 1.5 seconds or less, the deformation suppression of the paper S is preferably achieved. Further, in a case in which the time from the end of the ink droplet jetting to the start of the radiation heating is 1.0 second or less, the deformation of the paper S is most favorably suppressed.

That is, in a case in which the time from the end of the ink droplet jetting to the start of the radiation heating is 3.0 seconds or less, both the drying performance and the suppression of deformation of the paper S can be achieved. The time from the end of the ink droplet jetting to the start of the radiation heating is preferably 1.5 seconds or less and most preferably 1.0 second or less.

### [Evaluation of Paper Surface Reaching Temperature]

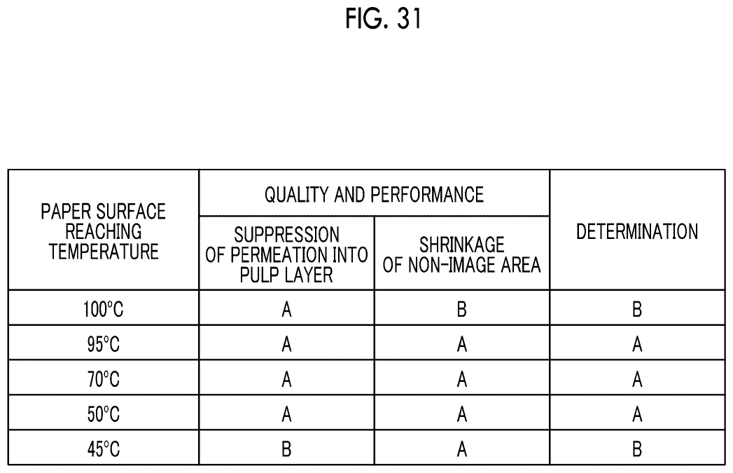

FIG. 31 is a table showing results of an evaluation test regarding a paper surface reaching temperature in the radiation drying. The paper surface reaching temperature is a temperature on a target surface of the paper S to be subjected to the radiation drying. The paper surface reaching temperature is measured using a noncontact thermometer.

The viewpoint of the evaluation of the quality and performance of the radiation drying is the suppression of the permeation into the pulp layer and the shrinkage of the non-image area. As an evaluation method, visual observation of the paper S after the radiation drying was applied. Evaluation A represents good, and Evaluation B represents inadequate.

As the paper surface reaching temperature, 45° C., 50° C., 70° C., 95° C., and 100° C. were applied. In a case in which the paper surface reaching temperature is 50° C. or higher and 100° C. or lower, the permeation of the moisture into the pulp layer is favorably suppressed. On the other hand, in a case in which the paper surface reaching temperature is less than 50° C. such as 45° C., the effect of heating the ink is insufficient, the permeation of the moisture at the initial stage of the drying treatment progresses, and the paper S may be deformed beyond an allowable range.

In a case in which the paper surface reaching temperature is 45° C. or higher and 95° C. or lower, the shrinkage of the non-image area falls within an allowable range. On the other hand, in a case in which the paper surface reaching temperature exceeds 95° C. such as 100° C., the volatilization rate of the moisture contained in the paper S is too high, and the shrinkage of the non-image area exceeding an allowable range occurs.

That is, in a case in which the paper surface reaching temperature is 50° C. or higher and 95° C. or lower, both the permeation suppression into the pulp layer and the shrinkage suppression of the non-image area are achieved.

In a case in which a contact drying device for the back surface SB of the paper S is provided at the downstream side position of the radiation drying device 49 shown in FIG. 28 in the paper transport direction, the back surface SB of the paper S can be directly dried, and the reaching temperature of the paper S after the radiation drying can be relatively increased.

In the embodiments of the present invention described above, the configuration elements can be changed, added, or deleted as appropriate without departing from the spirit of the present invention. The present invention is not limited to the embodiments described above, and various modifications can be made by those having ordinary knowledge in the field within the technical idea of the present invention.

### EXPLANATION OF REFERENCES

10: ink jet printing system
10A: ink jet printing system
12: paper feeding device
14: preliminary drying device
15: first pre-coating device
16: first printing device
16A: portion below first printing device
18: first drying device
20: paper inverting device
21: second pre-coating device
22: second printing device
23: inspection device
24: second drying device
26: stacking device
29: transport device
30: cooling roller
31: cooling roller temperature sensor
32: heat roller
33: heat roller temperature sensor
34: fan
36: pass roller
40: ink jet head
40C: ink jet head
40K: ink jet head
40M: ink jet head
40W: ink jet head
40Y: ink jet head
42: scanner
44: pass roller
46: tension pickup
46B: tension pickup
48: tension roller
48A: tension roller
48B: tension roller
48C: tension roller
49: radiation drying device
50: head module
50A: nozzle surface
52: head frame
54: dummy plate
56: flexible substrate
60: nozzle disposition portion
62: nozzle
64: nozzle opening
100: control device
100A: control device
101: system control unit
102: transport control unit
104: preliminary drying control unit
106: printing control unit
108: main drying control unit
110: inspection control unit
120: memory
122: sensor information acquisition unit
130: ink temperature information acquisition unit
130A: pre-coating liquid temperature information acquisition unit
132: moisture content setting unit
132A: moisture content setting unit
134: paper temperature setting unit
134A: paper temperature setting unit
136: table storage unit
138: drying condition setting unit
140: first moisture content sensor
140A: first moisture content sensor
142: second moisture content sensor
142A: second moisture content sensor
150: first paper temperature sensor
150A: first paper temperature sensor
152: second paper temperature sensor
152A: second paper temperature sensor
202: processor
204: computer-readable medium
204A: computer-readable medium
206: communication interface
208: input/output interface
210: bus
212: input device
214: display device
216: memory
216A: memory
218: storage
220: transport control program
221: pre-coating control program
222: printing control program
224: drying control program
226: inspection control program
230: temperature conversion table
232: ink temperature information
233: pre-coating liquid temperature information
234: paper moisture content information
234A: paper moisture content information
236: paper temperature information
236A: paper temperature information
300: drying device
310: first drying device
312: first hot air jetting device
314: first heat roller
320: second drying device
322: second hot air jetting device
324: second heat roller
S: paper
SA: front surface
SB: back surface
S10 to S34: each step of printing method
S100 to S107: each step of preliminary drying condition setting step

What is claimed is:

1. A printing system that performs double-sided printing of performing printing on a first surface of a substrate and then performing printing on a second surface of the substrate opposite to the first surface, the printing system comprising:
a first chemical liquid application device that applies a chemical liquid to the first surface of the substrate;
a second chemical liquid application device that applies the chemical liquid to the second surface of the substrate having the first surface to which the chemical liquid has been applied;
a temperature adjustment device that adjusts a temperature of the substrate;
a moisture content adjustment device that adjusts a moisture content of the substrate;
one or more processors; and
one or more memories in which programs to be executed by the one or more processors are stored,
wherein the one or more processors execute instructions of the programs to
acquire a temperature of the chemical liquid applied to the first surface of the substrate,
adjust the temperature of the substrate in a case in which the chemical liquid is applied to the first surface to a range exceeding 5.0° C. and lower than the acquired temperature of the chemical liquid,
set a second moisture content which is the moisture content of the substrate in a case in which the chemical liquid is applied to the second surface, and
adjust a first moisture content, which is the moisture content of the substrate in a case in which the chemical liquid is applied to the first surface, to a range of plus or minus 5.0% with respect to the second moisture content.

2. The printing system according to claim 1,
wherein the one or more processors adjust the first moisture content to a range of plus or minus 2.0% with respect to the second moisture content.

3. The printing system according to claim 1,
wherein the moisture content adjustment device is also used as the temperature adjustment device.

4. The printing system according to claim 3,
wherein the temperature adjustment device adjusts the temperature of the substrate by applying at least any of heat conduction, convection, radiation, or dielectric heating.

5. The printing system according to claim 3,
wherein the temperature adjustment device includes a heat conduction member that comes into contact with the substrate, and
the one or more processors adjust a surface temperature of the heat conduction member to 60° C. or higher and 140° C. or lower.

6. The printing system according to claim 3,
wherein the temperature adjustment device includes an air blowing device that blows air to the substrate, and
the one or more processors adjust a temperature of the blowing air to 80° C. or higher and 170° C. or lower.

7. The printing system according to claim 3,
wherein the temperature adjustment device includes an electromagnetic wave application device that applies an electromagnetic wave to the substrate, and
the one or more processors adjust a wavelength of the electromagnetic wave to 1000 nanometers or more and 8000 nanometers or less.

8. The printing system according to claim 7,
wherein the one or more processors adjust the wavelength of the electromagnetic wave to a range of 3000 nanometers plus or minus 1000 nanometers or a range of 6000 nanometers plus or minus 1000 nanometers.

9. The printing system according to claim 3,
wherein the temperature adjustment device includes a cooling device that cools the substrate.

10. The printing system according to claim 9,
wherein the cooling device includes a cooling roller that has an outer peripheral surface brought into contact with the substrate and that accommodates a cooling fluid therein.

11. The printing system according to claim 10,
wherein the cooling device includes a chiller device that supplies the cooling roller with an aqueous liquid adjusted to a specified temperature as the cooling fluid.

12. The printing system according to claim 3,
wherein the one or more processors automatically control the temperature adjustment device according to an application amount of the chemical liquid.

13. The printing system according to claim 3, further comprising:
a first moisture content sensor that detects the first moisture content, which is the moisture content of the substrate in a case in which the chemical liquid is applied to the first surface of the substrate, by using the first chemical liquid application device; and
a second moisture content sensor that detects the second moisture content, which is the moisture content of the substrate in a case in which the chemical liquid is applied to the second surface of the substrate, by using the second chemical liquid application device,
wherein the one or more processors automatically control the temperature adjustment device such that a moisture content difference calculated by subtracting the first moisture content from the second moisture content is set to zero.

14. The printing system according to claim 3, further comprising:
a first substrate temperature sensor that detects a first substrate temperature, which is the temperature of the substrate in a case in which the chemical liquid is applied to the first surface of the substrate, by using the first chemical liquid application device; and
a second substrate temperature sensor that detects a second substrate temperature, which is the temperature of the substrate in a case in which the chemical liquid is applied to the second surface of the substrate, by using the second chemical liquid application device,
wherein the one or more processors automatically control the temperature adjustment device such that a substrate temperature difference calculated by subtracting the first substrate temperature from the second substrate temperature is set to zero.

15. The printing system according to claim 1, further comprising:
a pretreatment liquid application device that applies a pretreatment liquid to the substrate as the chemical liquid.

16. The printing system according to claim 15,
wherein the temperature adjustment device and the moisture content adjustment device are disposed to avoid a position of a portion below the pretreatment liquid application device, and are disposed side by side along a substrate transport direction.

17. The printing system according to claim 16, further comprising:
a printing device that applies an ink to the substrate as the chemical liquid,
wherein the temperature adjustment device and the moisture content adjustment device are disposed to avoid a position of a portion below the printing device, and are disposed side by side along the substrate transport direction.

18. The printing system according to claim 1, further comprising:
a printing device that applies an ink to the substrate as the chemical liquid.

19. The printing system according to claim 18,
wherein the temperature adjustment device and the moisture content adjustment device are disposed to avoid a position of a portion below the printing device, and are disposed side by side along a substrate transport direction.

20. The printing system according to claim 1,
wherein the moisture content adjustment device includes at least any of a first moisture content adjustment device that adjusts a moisture content of the first surface of the substrate or a second moisture content adjustment device that adjusts a moisture content of the second surface of the substrate.

21. The printing system according to claim 20,
wherein the first moisture content adjustment device includes a first heat conduction member that comes into contact with the first surface, and
the second moisture content adjustment device includes a second heat conduction member that comes into contact with the second surface.

22. The printing system according to claim 21,
wherein the first moisture content adjustment device includes a first air blowing device that blows air to the first surface, and
the second moisture content adjustment device includes a second air blowing device that blows air to the second surface.

23. The printing system according to claim 1,
wherein the moisture content adjustment device includes a first air blowing device that blows air to the first surface as a first moisture content adjustment device that adjusts a moisture content of the first surface of the substrate, and a second air blowing device that blows air to the second surface as a second moisture content adjustment device that adjusts a moisture content of the second surface of the substrate.

24. The printing system according to claim 1, further comprising:
a first printing device that performs printing on the first surface,
wherein the temperature adjustment device includes a first electromagnetic wave irradiation device that irradiates the first surface with an electromagnetic wave after the printing on the first surface, and
the one or more processors start drying treatment for the first surface within 3.0 seconds after the printing on the first surface is completed.

25. The printing system according to claim 1, further comprising:
a first printing device that performs printing on the first surface,
wherein the temperature adjustment device includes a first electromagnetic wave irradiation device that irradiates the first surface with an electromagnetic wave after the printing on the first surface, and
the one or more processors start drying treatment for the first surface within 1.5 seconds after the printing on the first surface is completed.

26. The printing system according to claim 1, further comprising:
a first printing device that performs printing on the first surface,
wherein the temperature adjustment device includes a first electromagnetic wave irradiation device that irradiates the first surface with an electromagnetic wave after the printing on the first surface, and
the one or more processors start drying treatment for the first surface within 1.0 second after the printing on the first surface is completed.

27. The printing system according to claim 1, further comprising:
a second printing device that performs printing on the second surface,
wherein the temperature adjustment device includes a second electromagnetic wave irradiation device that irradiates the second surface with an electromagnetic wave after the printing on the second surface, and
the one or more processors start drying treatment for the second surface within 3.0 seconds after the printing on the second surface is completed.

28. The printing system according to claim 1, further comprising:
a second printing device that performs printing on the second surface,
wherein the temperature adjustment device includes a second electromagnetic wave irradiation device that irradiates the second surface with an electromagnetic wave after the printing on the second surface, and
the one or more processors start drying treatment for the second surface within 1.5 seconds after the printing on the second surface is completed.

29. The printing system according to claim 1, further comprising:
a second printing device that performs printing on the second surface,
wherein the temperature adjustment device includes a second electromagnetic wave irradiation device that irradiates the second surface with an electromagnetic wave after the printing on the second surface, and
the one or more processors start drying treatment for the second surface within 1.0 second after the printing on the second surface is completed.

30. The printing system according to claim 24,
wherein the one or more processors adjust a surface temperature of the first surface to 50° C. or higher and 95° C. or lower by using the first electromagnetic wave irradiation device.

31. The printing system according to claim 27,
wherein the one or more processors adjust a surface temperature of the second surface to 50° C. or higher and 95° C. or lower by using the second electromagnetic wave irradiation device.

32. The printing system according to claim 24, further comprising:
a tension application device that applies a tension of 58 newtons per meter or more and 1154 newtons per meter or less to the substrate irradiated with the electromagnetic wave from the first electromagnetic wave irradiation device.

33. The printing system according to claim 27, further comprising:
a tension application device that applies a tension of 58 newtons per meter or more and 1154 newtons per meter or less to the substrate irradiated with the electromagnetic wave from the second electromagnetic wave irradiation device.

34. A substrate state adjustment method of adjusting a state of a substrate in a case of performing double-sided printing of performing printing on a first surface of the substrate and then performing printing on a second surface of the substrate opposite to the first surface, the substrate state adjustment method comprising:
acquiring a temperature of a chemical liquid applied to the first surface;
adjusting a temperature of the substrate in a case in which the chemical liquid is applied to the first surface to a range exceeding 5.0° C. and lower than the acquired temperature of the chemical liquid;
setting a second moisture content which is a moisture content of the substrate in a case in which the chemical liquid is applied to the second surface; and
adjusting a first moisture content, which is a moisture content of the substrate in a case in which the chemical liquid is applied to the first surface, to a range of plus or minus 5.0% with respect to the second moisture content.

35. A non-transitory, computer-readable tangible recording medium on which a program for causing, when read by a computer, the computer to execute the substrate state adjustment method according to claim 34 is recorded.
